(19) United States
(12) Patent Application Publication
(10) Pub. No.: US 2007/0268226 A1
(43) Pub. Date: Nov. 22, 2007

(54) Video data control circuit, drive method thereof, and display device and electronic device having the video data control circuit

(75) Inventor: Masami Endo, Atsugi (JP)

Correspondence Address: ERIC ROBINSON, PMB 955, 21010 SOUTHBANK ST., POTOMAC FALLS, VA, 20165, US

(73) Assignee: Semiconductor Energy Laboratory Co., Ltd., Atsugi-shi (JP)

(21) Appl. No.: 11/798,816

(22) Filed: May 17, 2007

(30) Foreign Application Priority Data
May 19, 2006 (JP) 2006-140851

(51) Int. Cl. G09G 3/36

(52) U.S. Cl. 345/89

(57) ABSTRACT

It is an object of the present invention to provide a video data control circuit that satisfactorily displays an image on a display panel without increasing accesses to a frame memory or increasing power consumption when conducting vertical-horizontal image display conversion when video data is converted into digital video data for displaying in a predetermined digital gray scale. Another object is to provide a display device comprising the video data control circuit in which data is temporally kept in a line memory in a video data storage portion before the data is converted into digital video data for displaying in a predetermined digital gray scale. For example, a first digital video data is written to the line memory in a first order and read from the line memory in a second order different from the first order and output to a format conversion portion as a second digital video data.

### BACKGROUND OF THE INVENTION

1. Field of the Invention

The present invention relates to a video data control circuit. In addition, the present invention relates to a drive method of a video data control circuit. Specifically, the present invention relates to a video data control circuit for controlling and holding an image signal input to a pixel in an active matrix driving display device in which each pixel is provided with a switching element. More specifically, the present invention relates to a video data control circuit for expressing gray scale by control of a period in which a pixel is in a bright state or an area in which a sub-pixel included in a pixel is in a bright state. In addition, the present invention relates to a display device including a video data control circuit of the present invention and an electronic device having the display device including the video data control circuit in a display portion.

2. Description of the Related Art

In recent years, a display device using a light emitting element in which a thin semiconductor film is formed over an insulator such as a glass substrate, particularly, an active matrix display device using a TFT (thin film transistor) has been widely spread. An active matrix display device has several hundreds of thousands to several millions of TFTs in a pixel portion in which pixels are arranged in matrix, and the TFTs control charge of each pixel so that an image is displayed.

As a method for displaying gray scale in an active matrix display device, an analog gray scale display method (hereinafter, referred to as analog gray scale) and a digital gray scale display method (referred to as digital gray scale) are known. Digital gray scale in an active matrix display device includes an area gray scale method and a time gray scale method.

In a display device which displays an image by a time gray scale method or an area gray scale method, a video data control circuit (also refereed to as a panel controller) is needed for converting a format of inputted digital video data (or a digital image signal, hereinafter also referred to as video data) for time gray scale or area gray scale and for supplying the format-converted digital video data to a display panel at an appropriate timing. As an example, a structure of a video data control circuit in a display device with a time gray scale method is shown in FIG. 18 (see Patent Document 1: Japanese Published Patent Application No. 2004-163919).

In a video data control circuit in FIG. 18, video data is input to a video data control circuit 1800. The video data control circuit 1800 includes a format conversion portion 1801 which converts a format of inputted video data for time gray scale, a first frame memory 1802 and a second frame memory 1803 which memorize the format-converted video data in the format conversion portion 1801, and a display control portion 1805 which reads the video data memorized in the first frame memory 1802 and the second frame memory 1803 and transmits the data to a display panel 1804. The format conversion portion 1801 and the display control portion 1805 are connected to the first frame memory 1802 and the second frame memory 1803 through a selector 1806 and a selector 1807. The format conversion portion 1801 and the display control portion 1805 are connected to each other so as to operate in synchronization.

In the video data control circuit 1800 in FIG. 18, in one frame period, the video data converted in the format conversion portion 1801 is written to the first frame memory 1802, while format-converted video stored in the second frame memory 1803 is read by the display control portion 1805 to be transmitted to the display panel 1804; in the following frame period, on the other hand, the video data is written to the second frame memory 1803, while the video data in the first frame memory 1802 is read by the display control portion 1805 to be transmitted to the display panel 1804. These operations are repeated alternately. In other words, roles of the first frame memory 1802 and the second frame memory 1803 are switched when the frame changes. An inexpensive SRAM, which has large capacity, is preferably used as the first frame memory 1802 and the second frame memory 1803.

### SUMMARY OF THE INVENTION

In conducting display by a time gray scale method and an area gray scale method, digital video data to be input to a display panel needs to be format-converted into a predetermined format in a video data control circuit as described above.

On the other hand, in recent years, in conducting display with digital video data by a display panel, the display panel is expected to conduct various kinds of display. For example, the display panel is expected to convert vertical display to/from horizontal display (hereinafter, also referred to as vertical-horizontal conversion) of an image to be displayed instantaneously and correctly.

However, since digital video data which is format-converted into a predetermined format is converted again in vertical-horizontal conversion, rearrangement of digital video data to be input to the display panel makes reading of video data stored in the frame memory complicated. This is one reason for increase in power consumption of reading video data stored in the frame memory and for delay in access time.

A problem in vertical-horizontal conversion in format-converted digital video data is described with reference to FIGS. 19A to 19C. In FIGS. 19A to 19C described below, a display panel having 6 rows and 5 columns is used so that specific description can be made and an example in which video data to be input to the display panel with 6 rows and 5 columns is vertical-horizontal converted is described. Further, in FIGS. 19A to 20D, the description is made using 2-bit digital video data as the digital video data to be input to the display panel having a matrix of 6 rows and 5 columns, and a letter “T” as an image to be displayed on the display panel so that specific description can be made.

FIG. 19A shows a schematic view of the digital video data to be input to the display panel aligned in serial. In FIG. 19A, each block indicates video data to be input to each pixel. Hatching in a block 1901 in FIG. 19A corresponds to (1, 0) in 2-bit digital video data. Hatching in a block 1902 corresponds to (0, 1) in 2-bit digital video data. Blank in a block 1903 corresponds to (0, 0) in 2-bit digital video data. In addition, in the following description, it is assumed that the digital video data is to be input to a video data control circuit in an increasing numerical order in FIG. 19A, that is, along a direction indicated by an arrow in FIG. 19A.

Note that, in this specification, video data (0, 1) corresponds to data in which the first bit is “1” and the second bit is “0”.

FIG. 19B shows schematic view of an image of the digital video data which is aligned in serial in FIG. 19A displayed in pixels in the display panel with matrix of 6 rows and 5 columns. In FIG. 19B, a gate driver 1904 is provided in a vertical direction and a source driver 1905 is provided in a horizontal direction. When the image shown in FIG. 19B is displayed, 2-bit digital video data shown in FIG. 19C is input to each pixel in FIG. 19B in one frame period. Note that, in a time gray scale method, one frame period includes a first sub-frame in which either lighting or non-lighting of a light emitting element is selected corresponding to either a first or second bit of the 2-bit digital video data and a second sub-frame in which either lighting or non-lighting of the light emitting element is selected corresponding to the other one of the first and second bit of the 2-bit digital video data.

In other words, digital video data is input to a source driver and a gate driver in the display panel having 6 rows and 5 columns in an order as indicated by an arrow in FIG. 19B and the source driver and the gate driver is driven, whereby ordinary display can be conducted.

However, in displaying the video data shown in FIG. 19A on a display panel with 5 rows and 6 columns, which is a vertical-horizontal converted display panel that is, the display panel rotated to the left by 90°, if the data is input to pixels as it is as shown in FIG. 20A, an image which is different from the one which is desired to be displayed is displayed. Therefore, rearrangement of video data to be input to the pixels is necessary to display the image on the display panel. For example, in a liquid crystal display device which conducts display with analog gray scale, a vertical-horizontal converted image can be displayed by change of a scanning direction of a source driver.

On the other hand, in a case of a digital gray scale mode such as a time gray scale method, display data for one frame period needs to be format-converted into plural pieces of display data and to be output to the display panel so that sub-frame display can be conducted. Therefore, in displaying the video data shown in FIG. 19A on the display panel having 5 rows and 6 columns, which is a vertical-horizontal converted display panel, that is, the display panel rotated to the left by 90°, the display is conducted as follows: a portion of the pixels or digital video data input to the pixels is masked as shown in FIG. 20B and the image is displayed with a smaller size than actually displayed without rearrangement of the video data input to the display panel.

When conducting display with a mask covering a display portion in a display panel, it is possible for display to be conducted by rearranging video data for the pixel and the video data which do not contribute to display, as shown in FIG. 20B. In specific, in displaying the digital video data stored in a frame memory in a format conversion portion on the display panel having 5 rows and 6 columns, which is a vertical-horizontal converted display panel, that is, the display panel rotated to the left by 90°, it is necessary that the digital video data is rearranged to be output to the pixels in an order as indicated by an arrow in FIG. 20C so that display shown in FIG. 20C is conducted. In FIG. 20C, the display panel has a structure in which a gate driver 2004 is provided in a horizontal direction and a source driver 2005 is provided in a vertical direction. When an image shown in FIG. 20C is displayed, 2-bit digital video data shown in FIG. 20D is input to each pixel in FIG. 20C in one frame period. Note that, in a time gray scale method, one frame period includes a first sub-frame in which either lighting or non-lighting of a light emitting element is selected corresponding to either a first or second bit of the 2-bit digital video data and a second sub-flame in which either lighting or non-lighting of the light emitting element is selected corresponding to the other one of the first and second bit of the 2-bit digital video data.

However, in the video data control circuit shown in FIG. 18, data for a plurality of sub-frames, which is data for one frame, is stored together in the frame memory in a case of a predetermined digital gray scale method such as a time gray scale method. In order to read video data for horizontal display as video data for vertical display, a reading order of the stored data needs to be changed. Therefore, an access to a column decoder and a row decoder in the frame memory becomes complicated; accordingly, an access to the frame memory becomes frequent, which leads to delay in access time and increase in power consumption.

Although an example of 2-bit data is shown here, digital video data which is actually used in a display device is multi-bit video data. Therefore, delay in access time and increase in power consumption become more apparent.

As described above, in a conventional video data control circuit or in a display device including the video data control circuit, when reading video data kept in a frame memory in conducting vertical-horizontal conversion of an image to be displayed on a display panel, an access to a column decoder and a row decoder in the memory becomes complicated. Accordingly, the number of accesses to the memory is increased and power consumption is increased.

In addition, time needed for reading out video data to be stored in the frame memory is increased when conducting vertical-horizontal conversion of an image to be displayed on the display panel; therefore, it is difficult to perform satisfactory display of the image on the display panel.

In view of the foregoing, in conducting a vertical-horizontal conversion of the image to be displayed when video data is converted into digital video data for displaying in a predetermined digital gray scale, it is an object of the present invention to provide a video data control circuit which can satisfactorily display an image on a display panel without increase in the number of accesses to a frame memory nor increase the power consumption. In addition, it is another object of the present invention to provide a display device including the video data control circuit.

In order to solve the foregoing problem, the present invention has a structure where data is temporally kept in a line memory in a video data storage portion provided in a video data control circuit before the data is converted into digital video data for display with predetermined digital gray scale. The digital video data to be kept in the line memory is written to the line memory in a first order and read from the line memory in a second order which is different from the first order. The read digital video data is second digital video data and the second video data is output to a format conversion portion provided in a video data control circuit. In addition, the present invention includes a display device including the video data control circuit and an electronic device including the display device. A specific structure of the present invention is described as follows.

One structure of a video data control circuit of the present invention includes a video data storage portion which converts first video data input thereto into second video data and outputs the second video data, and a format conversion portion which format-converts the second video data input thereto into video data so that the video data is displayed with predetermined digital gray scale, in which the video data storage portion has a first line memory and a second line memory, and the video data storage portion writes the first video data into the first line memory or the second line memory in a first order, and reads out the first video data written in a second order which is different from the first order, so that the second video data which is different from the first video data is output to the format conversion portion.

Another structure of a video data control circuit of the present invention includes a video data storage portion which converts first video data input thereto into second video data and outputs the second video data, and a format conversion portion which format-converts the second video data input thereto into video data in which one frame period is divided into n sub-frame periods (n is a natural number of 2 or more) and lighting or non-lighting is selected for each pixel in each of the n sub-frame periods so as to express gray scale; in which the video data storage portion has a first line memory and a second line memory, and the video data storage portion writes the first video data into the first line memory or the second line memory in a first order, and reads out the first video data, which is written in a second order which is different from the first order, so that the second video data different from the first video data is output to the format conversion portion.

In the present invention, the first video data and the second video data may be multi-bit digital video data.

In the present invention, the first line memory and the second line memory may be volatile memories.

One aspect of a display device of the present invention includes a display panel having a plurality of pixels; and a video data control circuit having a video data storage portion which converts first video data input thereto into second video data and outputs the second video data, having a format conversion portion which format-converts the second video data input thereto into third video data so that the video data is displayed with predetermined digital gray scale, and supplying the third video data to the display panel; in which the video data storage portion has a first line memory and a second line memory, and the video data storage portion writes the first video data into the first line memory or the second line memory in a first order, and reads out the first video data written in a second order which is different from the first order so that the second video data, which is different from the first video data, is output to the format conversion portion.

Another aspect of a structure of the present invention includes a display panel having a plurality of pixels; and a video data control circuit having a video data storage portion which converts first video data input thereto into second video data and outputs the second video data, having a format conversion portion which format-converts the second video data input thereto into third video data in which one frame period is divided into n sub-frame periods (n is a natural number of 2 or more) and lighting or non-lighting is selected for each pixel in each of the n sub-frame periods so as to express gray scale, and supplying the third video data to the display panel; in which the video data storage portion has a first line memory and a second line memory, and the video data storage portion writes the first video data into the first line memory or the second line memory in a first order, and reads out the first video data, which is written, in a second order which is different from the first order, and output to the format conversion portion as the second video data which is different from the first video data.

In the present invention, the first to the third video data may be multi-bit digital video data.

In the present invention, the first line memory and the second line memory may be volatile memories.

Note that a display device of the present invention includes a liquid crystal display device, a DMD (Digital Micromirror Device), a PDP (Plasma Display Panel), an FED (Field Emission Display), a display device which conducts display with a signal input to a gate line and a source line in its category, in addition to a display device in which light emitting elements typified by an organic light emitting diode (OLED) is provided in each pixel.

In addition, the light emitting element in this specification includes an element of which luminance is controlled by current or voltage in its category. In specific, an OLED (Organic Light Emitting Diode), inorganic EL (Electro luminescence), an MIM type electron source element (electron-emissive element) used in an FED (Field Emission Display), and the like are included.

In addition, the display device includes a panel in which a light emitting element is sealed, and a module in which an IC and the like including a controller is mounted on the panel. In addition, the display device includes a panel in which a liquid crystal element is sealed, and a module in which an IC and the like including a controller is mounted on the panel.

As a transistor provided in each pixel in the display device in the present invention, a thin film transistor using a polycrystalline semiconductor or a microcrystalline semiconductor (including a semiamorphous semiconductor), or an amorphous semiconductor can be used, but a transistor used in a light emitting device in the present invention is not limited to a thin film transistor. A transistor formed using single crystalline silicon or a transistor using SOI may be used. Alternatively, a transistor using an organic semiconductor, a transistor using a carbon nanotube, or a transistor using zinc oxide may be used. A transistor provided in a pixel in a light emitting device of the present invention may have a single gate structure, a double gate structure, or a multi-gate structure including more than two gates.

With the present invention, in a video data control circuit for conducting format conversion of video data and a display device including the video data control circuit, reading of video data stored in a frame memory in a format conversion portion can be sufficiently conducted; therefore, increase in power consumption and delay in access time in reading of the video data stored in the frame memory can be prevented. In other words, lower power consumption and higher access speed can be realized in the video data control circuit.

In the present invention, a structure where a first line memory and a second line memory are provided in a video data control circuit for conducting format conversion of video data and a display device including the video data control circuit is employed; therefore, video data to be input to the format conversion portion is delayed and a timing margin in which the video data is written into the first frame memory and the second frame memory can be provided.

Further, in the present invention, since a pipeline processing is employed, in which a writing and reading process of video data stored in the first line memory and the second line memory, and a writing and reading process of video data stored in the first frame memory and the second frame memory are sequentially conducted, the format of the video data can be efficiently converted into the format which is actually to be displayed.

### BRIEF DESCRIPTION OF DRAWINGS

FIG. 1 illustrates an embodiment mode of the present invention;

FIG. 2 illustrates an embodiment mode of the present invention;

FIGS. 3A to 3E illustrate an embodiment mode of the present invention;

FIG. 4 illustrates an embodiment mode of the present invention;

FIGS. 5A to 5C illustrate an embodiment mode of the present invention;

FIG. 6 illustrates an embodiment mode of the present invention;

FIG. 7 illustrates an embodiment mode of the present invention;

FIG. 8 illustrates an embodiment mode of the present invention;

FIGS. 9A and 9B illustrate an embodiment mode of the present invention;

FIGS. 10A and 10B illustrate an embodiment mode of the present invention;

FIGS. 11A to 11C illustrate an embodiment mode of the present invention;

FIGS. 12A and 12B illustrate an embodiment of the present invention;

FIGS. 13A to 13C illustrate an embodiment of the present invention;

FIGS. 14A to 14C illustrate an embodiment of the present invention;

FIGS. 15A to 15C illustrate an embodiment of the present invention;

FIG. 16 illustrates an embodiment of the present invention;

FIGS. 17A to 17E illustrate an embodiment of the present invention;

FIG. 18 is a block diagram illustrating a conventional example;

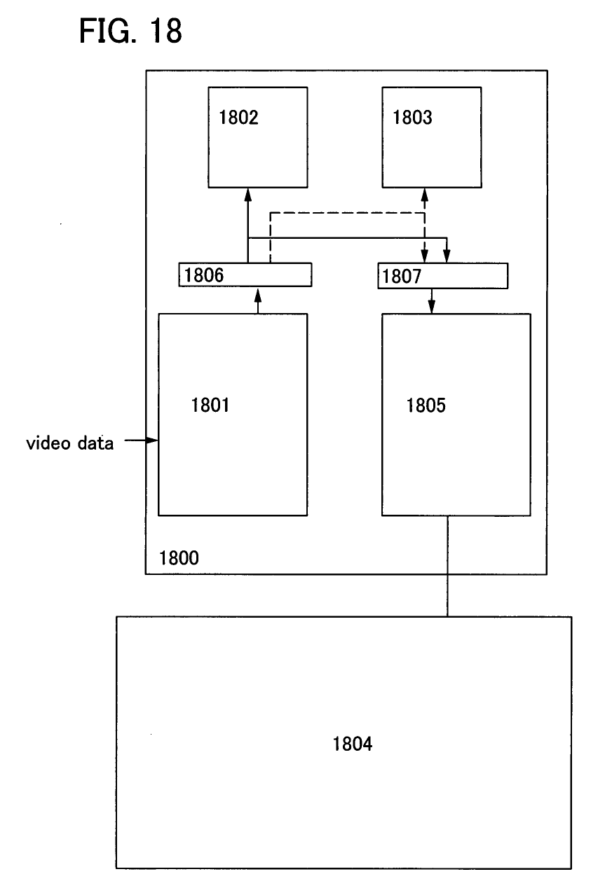

FIGS. 19A to 19C are block diagrams illustrating a conventional example; and

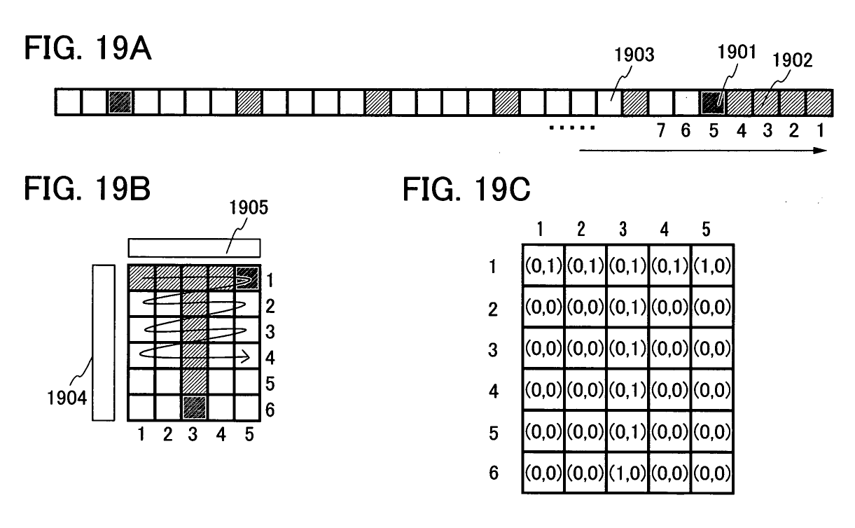

FIGS. 20A to 20D are block diagrams illustrating a conventional example.

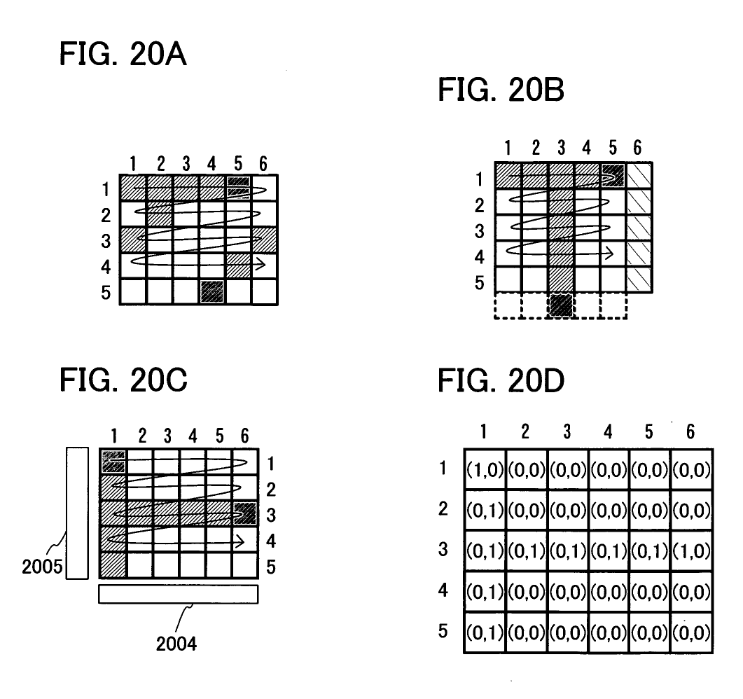

### DETAILED DESCRIPTION OF THE INVENTION

Hereinafter, embodiment modes and embodiments of the present invention are described with reference to the accompanying drawings. The present invention can be carried out in many different modes, and it is easily understood by those skilled in the art that modes and details can be modified in various ways without departing from the purpose and the scope of the present invention. Accordingly, the present invention should not be interpreted as being limited to the description of the embodiment modes and embodiments to be given below. Note that like portions in the drawings for describing embodiment modes and embodiments are denoted by the like reference numerals and repeated explanations thereof are omitted.

### Embodiment Mode 1

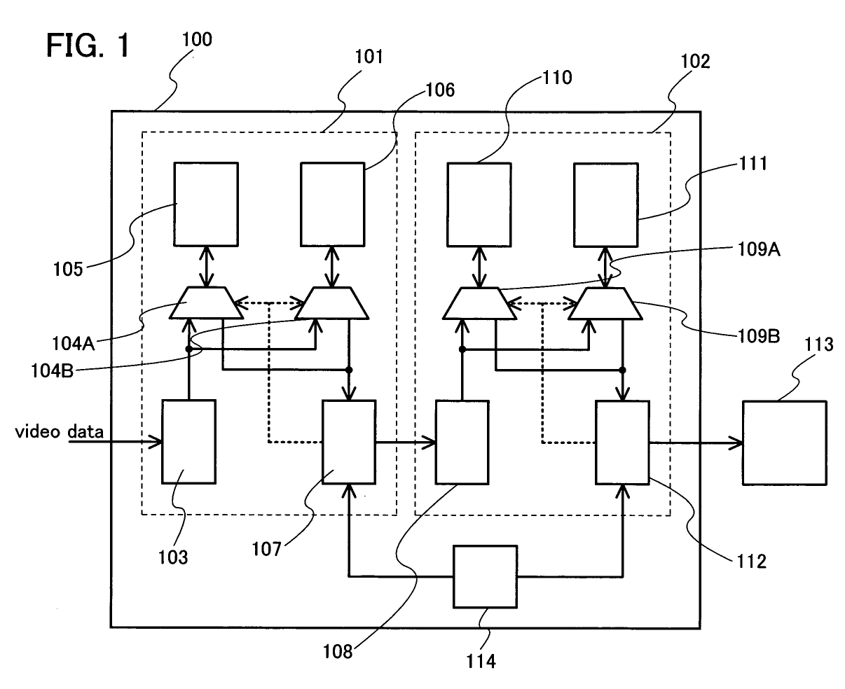

FIG. 1 shows a block diagram of a video data control circuit in this embodiment mode. A detailed description thereof is given below. Note that, in the present invention, a video data control circuit refers to one which coverts format of inputted digital video data into a format for displaying the video data with predetermined digital gray scale, and outputs the data to a display device. In the present invention, a display device refers to a structure including a video data control circuit and a display panel provided with a plurality of pixels having a self-light emitting element such as a liquid crystal element, an EL element, or an element used in an FED. The display panel may also refer to a display panel main body which includes a plurality of pixels and a peripheral drive circuit for driving the pixels over a substrate. In addition, the display panel may also be provided with a flexible printed circuit (FPC) or a printed wiring board (PWB).

FIG. 1 illustrates a basic structure of a video data control circuit of the present invention. A video data control circuit 100 shown in FIG. 1 includes a video data storage portion 101 and a format conversion portion 102. The video data storage portion 101 includes a video data writing portion 103, a selector 104A, a selector 104B, a first line memory 105, a second line memory 106, and a video data reading portion 107. The format conversion portion 102 includes a video data format conversion portion 108, a selector 109A, a selector 109B, a first frame memory 110, a second frame memory 111, and a display control portion 112. Video data output from the display control portion 112 in the video data control circuit 100 is supplied to a display panel 113. In addition, the video data control circuit 100 includes a memory control portion 114 which is connected to the video data reading portion 107 in the video data storage portion 101 and the display control portion 112 in the format conversion portion 102, and which changes a format of video data output from the video data control circuit corresponding to vertical-horizontal conversion on the display panel 113.

In the video data storage portion 101 in FIG. 1, first video data input to the video data writing portion 103 is written to the first line memory 105 or the second line memory 106 through the selector 104A and the selector 104B in a first order, and the video data is read by the video data reading portion 107 through the selector 104A and the selector 104B in a second order. Second video data output from the video data reading portion 107 in the video data storage portion 101 is input to the video data format conversion portion 108 and a format thereof is converted so that the video data is displayed with predetermined digital gray scale, then, the video data for one frame is stored in the first frame memory 110 or the second frame memory 111 through the selector 109A or the selector 109B. The video data stored in the frame memory 110 and the second frame memory 111 is read by the display control portion 112 and output to the display panel 113 as third video data. In the video data control circuit 100, the memory control portion 114 which controls the video data reading portion 107 in the video data storage portion 101 and the display control portion 112 in the format conversion portion 102 and changes a format of an outputted signal to be output corresponding to vertical-horizontal conversion or the like on the display panel 113 controls the selectors 104A and 104B and the selectors 109A and 109B.

In FIG. 1, the video data reading portion 107 in the video data storage portion 101 controls the selector 104A and the selector 104B (see a dotted arrow in FIG. 1) so that writing of the first video data input from the video data writing portion 103 into the first line memory 105 or the second line memory 106 is controlled. In addition, while writing the first video data into either one of the first line memory 105 and the second line memory 106 with a predetermined address, the selector 104A and the selector 104B are controlled so that the second video data stored in the other one of the first line memory 105 and the second line memory 106 is read out to the video data reading portion 107.

In FIG. 1, the display control portion 112 in the format conversion portion 102 controls the selector 109A and the selector 109B (see a dotted arrow in FIG. 1) so that writing of video data which is format-converted by the video data format conversion portion 108 into the first frame memory 110 or the second frame memory 111, which is changed by frame, is controlled. In addition, while writing the format-converted video data into either one of the first line memory 110 and the second line memory 111, the selector 109A and the selector 109B are controlled so that the third video data stored in the other one of the first line memory 110 and the second line memory 111 is read out to the display control portion 112.

Note that the video data reading portion 107 controlling the selectors 104A and 104B and the display control portion 112 controlling the selector 109A and the selector 109B are controlled by the memory control portion 114 provided in the video data control circuit 100. The memory control portion 114 controls writing and reading of the video data to be stored in the first line memory 105 and the second line memory 106 or the first frame memory 110 and the second frame memory 111 and reading of the video data stored in the first line memory 105 and the second line memory 106 or the first frame memory 110 and the second frame memory 111, corresponding to the vertical-horizontal conversion on the display panel 113.

Note that, in the present invention, the description is made assuming that the first video data to be stored in the first line memory 105 or the second line memory 106 is sequentially stored and read depending on a bus width for data inputting and outputting to/from the first line memory 105 and the second line memory 106. The second video data in this specification refers to video data which is rearranged by being written to the first line memory 105 or the second line memory 106 in the first order and read in the second order. In addition, the description is made assuming that the format-converted second video data to be stored in the first frame memory 110 or the second frame memory 111 is sequentially stored and read depending on a bus width for data inputting and outputting to/from the first frame memory 110 or the second frame memory 111. Video data which is converted by being stored temporally in the first frame memory 110 or the second frame memory 111 and read so as to be displayed in a vertical-horizontal converted manner on the display panel 113 with predetermined digital gray scale is referred to as the third video data in this specification.

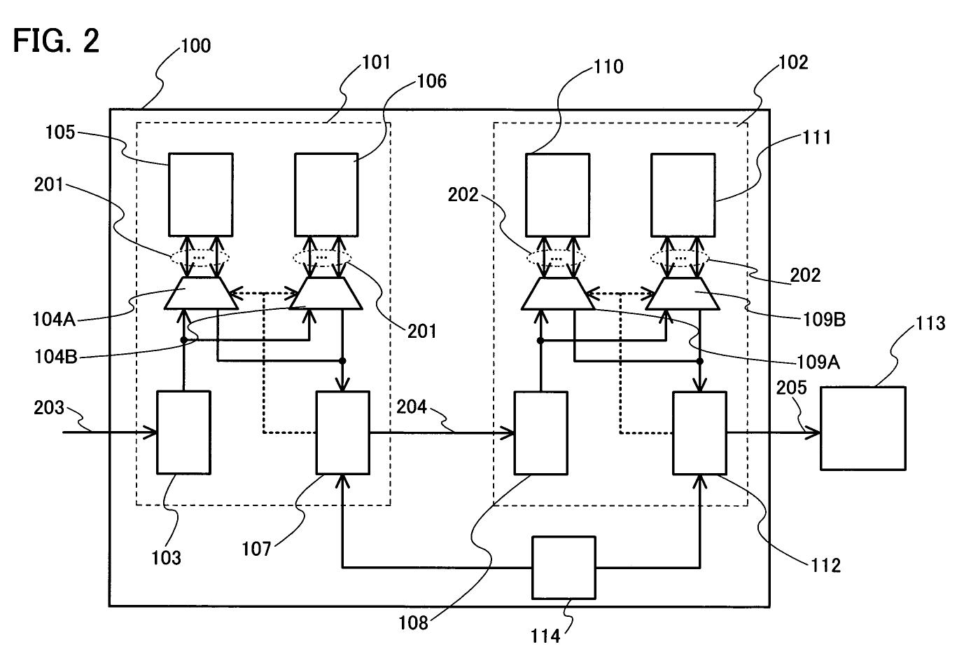

Then, a structure of a video data control circuit in the present invention is described with reference to FIG. 2. FIG. 2 shows a data bus width 201 for data inputting and outputting to/from the first line memory 105 or the second line memory 106, a data bus width 202 for data inputting and outputting to/from the first frame memory 110 or the second frame memory 111, and inputting and outputting of the first video data 203, the second video data 204, and the third video data 205, in the structure illustrated in FIG. 1.

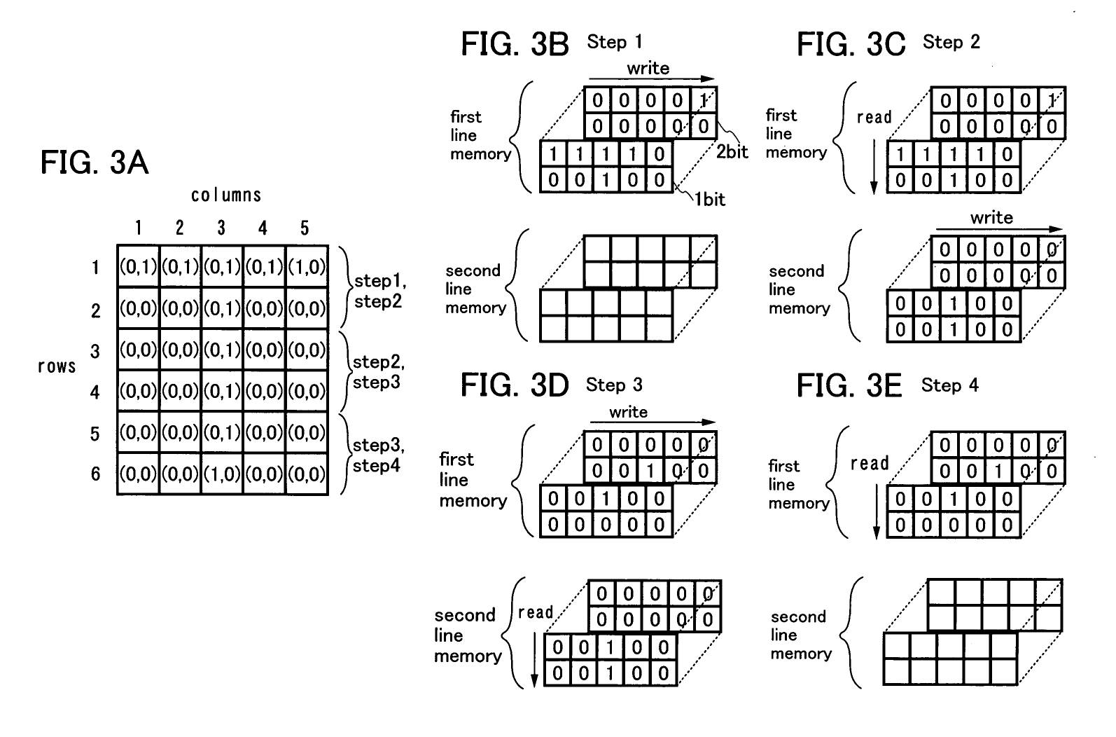

The present invention has a structure where the data bus width 201 for data inputting and outputting to/from the first line memory 105 and the second line memory 106, and the data bus width 202 for data inputting and outputting to/from the first frame memory 110 and the second frame memory 111 are the same. Below is a description of writing of the first video data and reading of the second video data in the first line memory 105 or the second line memory 106 according to the present invention with reference to the illustrated examples of FIGS. 3A to 5C. Note that FIGS. 3A to 5C show an example where the bus width for data inputting and outputting (hereinafter, referred to as a data bus width) is two and the first video data to be input is 2-bit video data. The structures of the first and second line memories and the first and second frame memories used in the description of FIGS. 3A to 5C are the same structures as the first and second line memories and the first and second frame memories described in FIGS. 1 and 2.

First, the first video data 203 with which an image shown in FIG. 3A is displayed on the display panel is input to the video data writing portion 103 in the video data storage portion 101 in FIG. 1. Note that the first video data is video data for displaying a letter “T” on the display panel in a vertical mode.

As shown in FIG. 3B, video data corresponds to a data bus width of the first line memory 105 or the second line memory 106, that is, video data for two rows (a first row and a second row) of a display panel in FIG. 3A is written into the first line memory 105 (step 1). In writing to the first line memory 105, the video data for a first row and a second row in the display panel 113 is sequentially written to a first column, a second column, a third column, and so on.

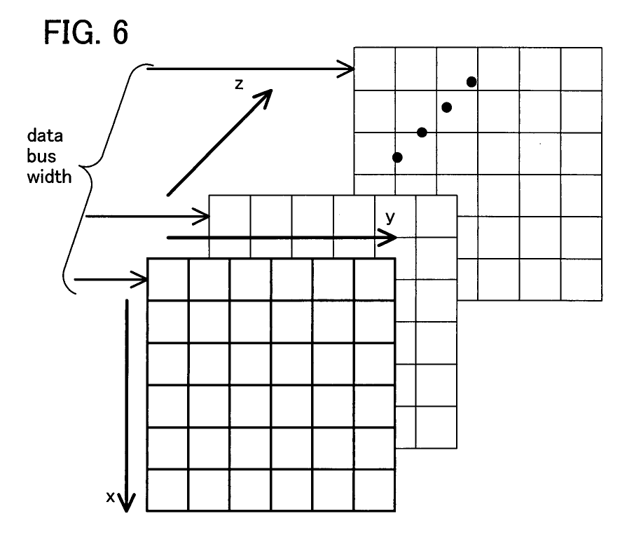

Note to describe storage of the video data in the first line memory 105 and the second line memory 106, addresses in the first line memory 105 and the second line memory 106 in a row direction, a column direction, and a depth direction is referred to as an “x-direction”, a “y-direction”, and a “z-direction”, respectively. In other words, writing of video data to the first line memory in FIG. 3B is conducted as follows: the video data in the first row and the second row is written in the x-direction, the video data in the first to fifth columns is written in the y-direction, and the video data in the first and second bits is written in the z-direction, sequentially. Note that, in this specification, the description of the first and second line memories and the first and second frame memories is made below assuming that directions denoted as the x-direction and the y-direction are address directions and a direction denoted as the z-direction is a data bus width. Note that the x-direction and the y-direction, which are the address directions, are named for the sake of description and they do not denote any specific position or direction. In addition, the data bus width in FIG. 6 desirably corresponds to the number of bits of the inputted video data, and in a case where 2-bit video data described in this embodiment mode is input to each memory, 2-data bus width is desirably provided. Note that the present invention may have a structure where 2 p-data bus width or 0.5 p-data bus width is provided corresponding to input of p-bit video data (p is a natural number), depending on a process speed of a memory. However, a data bus width of the same number as bits of video data is preferable in consideration of a large memory.

The step 1 in FIG. 3B can be also described as follows: video data for a bus width of the first line memory 105 or the second line memory 106, corresponding to the number of bits of the first video data, is sequentially written in the z-direction of the first line memory, video data for two rows (the first row and the second row) of the display panel is written in the y-direction of the first line memory, and when the writing in the y-direction finishes, video data is sequentially written in the x-direction of the first line memory from the first row to the second row in the display panel 113.

Note that, in FIGS. 3B to 3E, a 2×5 block in lower left and a 2×5 block in upper left in drawings store video data for the first bit and video data for the second bit, respectively.

Then, as shown in FIG. 3C, video data for the bus width of the first line memory 105 or the second line memory 106, corresponding to the number of bits of the first video data, is sequentially written in the z-direction of the second line memory, the video data for two rows (a third row and a fourth row) of the display panel in FIG. 3A is written in the y-direction of the second line memory. When the writing in the y-direction finishes, video data is sequentially written in the x-direction of the second line memory from the third row to the fourth row in the display panel 113. In addition, while the writing to the second line memory is conducted, the video data which is written into the first line memory in the step 1 is read. In reading of the video data from the first line memory 105 in FIG. 3C, the video data for the bus width of the first line memory 105 or the second line memory 106, corresponding to the number of bits of the first video data, is sequentially read in the z-direction of the first line memory, then, the video data is read in the x-direction from an address in the first line memory in which video data for the first row and the first column is written. When the reading in the x-direction finishes, the reading is sequentially conducted in a first column, a second column, a third column, and so on in the display panel 113, in the y-direction of the first line memory (step 2).

Then, as shown in FIG. 3D, video data for the bus width of the first line memory 105 or the second line memory 106, corresponding to the number of bits of the first video data, is sequentially written in the z-direction of the first line memory, the video data for two rows (a fifth row and a sixth row) of the display panel in FIG. 3A is written in the y-direction of the first line memory. When the writing in the y-direction finishes, video data is sequentially written in the x-direction of the first line memory from the fifth row to the sixth row in the display panel 113. In addition, while the writing to the first line memory is conducted, the video data which is written into the second line memory in the step 2 is read. In reading of the video data from the second line memory 106 in FIG. 3D, the video data for the bus width of the first line memory 105 or the second memory 106, corresponding to the numbers of bits of the first video data, is sequentially read in the z-direction of the second line memory, then, video data is read in the x-direction from an address in the second line memory in which video data for the third row and the first column is written. When the reading in the x-direction finishes, the reading is sequentially conducted in a first column, a second column, a third column, and so on in the display panel 113, in the y-direction of the second line memory (step 3).

Then, as shown in FIG. 3E, the video data which is written to the first line memory in the step 3 is read. In reading of the video data from the first line memory 105 in FIG. 3E, the video data for the bus width of the first line memory 105 or the second line memory 106, corresponding to the number of bits of the first video data is sequentially read in the z-direction of the first line memory, then, video data is read in the x-direction from an address in the first line memory in which video data for the fifth row and the first column is written. When the reading in the x-direction finishes, the reading is sequentially conducted in a first column, a second column, a third column, and so on in the display panel 113, in the y-direction of the first line memory (step 4).

As described above, in an example shown in FIGS. 3B to 3E, the first order of the present invention is an order in which writing to the first line memory or the second line memory is conducted, that is, an order in which writing is conducted in the y-direction and then conducted in the x-direction. On the other hand, the second order is an order in which reading from the first line memory or the second line memory is conducted, that is, an order in which reading is conducted in the x-direction and then conducted in the y-direction. In this embodiment mode, the foregoing first order and second order are employed in order to conduct vertical-horizontal conversion on a display panel, but it is not limited thereto. It can be said that the foregoing first order and second order are employed for conducting vertical horizontal conversion on a display panel in this embodiment mode; however, the vertical horizontal conversion is not limited thereto, and when the first order and the second order are made different from each other to read out data, an advantage similar to that of the present invention can be obtained.

Note that although an example in which 2-bid video data is input to the display panel with pixels in 6 rows and 5 columns to conduct display is described, in practice, the present invention can be applied to a case in which s-bit video data (s is a natural number) is input to a display panel with pixels in m rows and n columns (m and n are natural numbers of 2 or more) to conduct display. In addition, memory capacity of the first line memory and the second line memory, and the number of addresses of the memory to be used may be appropriately set in accordance with the size of the first video data to be input.

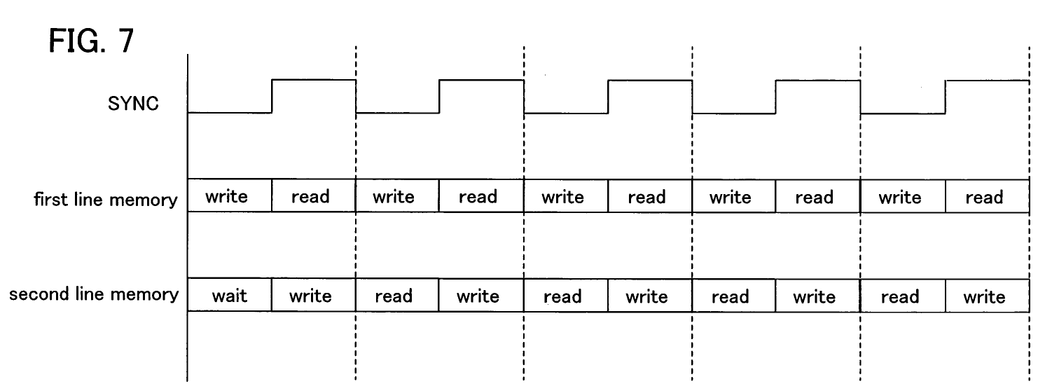

A timing chart of writing and reading of the first video data to/from the first line memory 105 or the second line memory 106 is briefly described. FIG. 7 shows a timing chart of a synchronization signal (SYNC), writing and reading to/from the first line memory 105, and writing and reading to/from the second line memory 106.

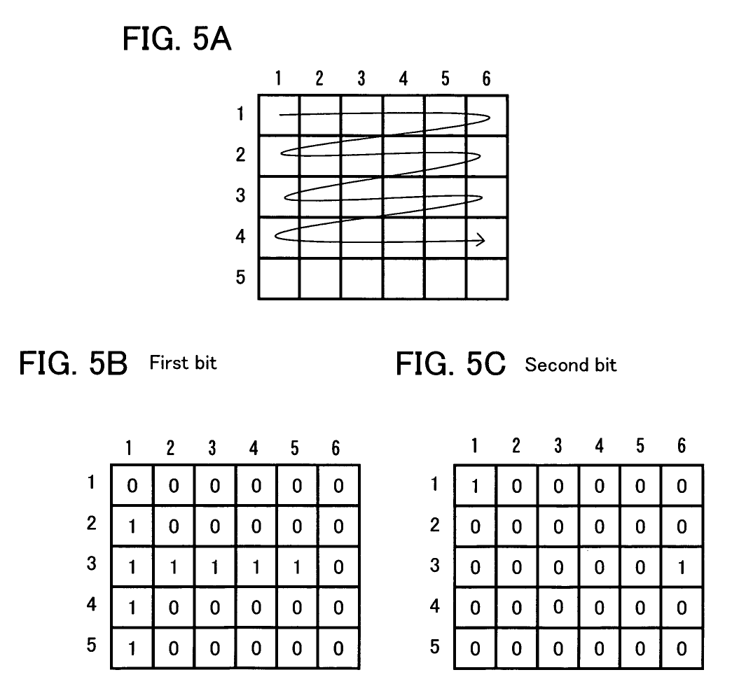

As shown in FIG. 7, when the synchronization signal changes, writing to the first line memory 105 and reading from the second line memory 106 are changed to reading from the first line memory 105 and writing to the second line memory 106. Since a video data control circuit of the present invention conducts writing or reading of the first line memory 105 or the second line memory 106 alternately as shown in FIGS. 5A to 5C, a memory access timing margin can be ensured without necessity of a large capacity and high-speed operation memory. In addition, a video data control circuit of the present invention can operate at high speed without a RAM with large capacity, even if the amount of information of the video data is increased, and can realize reduction in size, manufacturing cost, and power consumption of a product.

In addition, as a memory used for the first line memory 105 and the second line memory 106, a static memory (SRAM), a dynamic memory (DRAM), a ferroelectric memory (FeRAM), an EEPROM, a flash memory, and the like can be given, but it is not limited thereto. A memory element which is used in general may be employed. Note that, in the case of using a DRAM for the line memory, a regular refresh is additionally needed.

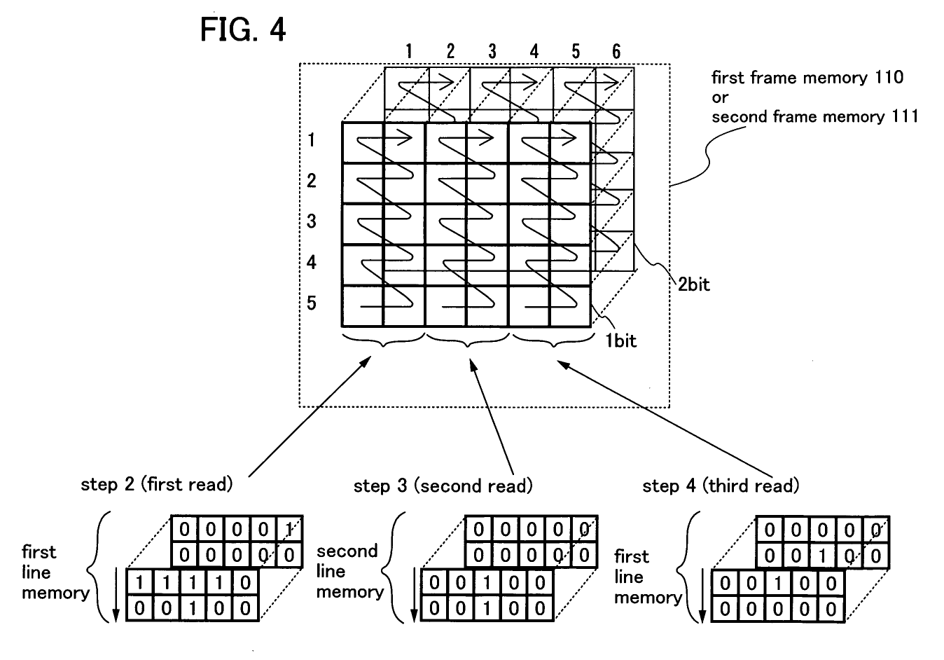

Next, an operation of writing of the second video data, which is read from the first line memory 105 and the second line memory 106, to the first frame memory or the second frame memory through the format conversion portion is described in detail with reference to FIG. 4, following the description of FIGS. 3A to 3E.

The second video data read from the first line memory 105 and the second line memory 106 in the steps 2, 3, and 4 in FIGS. 3C to 3E is divided into frames to be stored in the first frame memory 110 and the second frame memory 111. In FIG. 4, writing to the first frame memory and the second frame memory are conducted in the order in which the second video data in the first line memory or the second line memory is read (a first reading, a second reading, and a third reading in FIG. 4). Note that the writing to the first frame memory or the second frame memory is preferably conducted to adjacent addresses so that the written data can be easily read.

Then, reading of the video data written into the first frame memory and the second frame memory described in FIG. 4 is described. The video data stored in the first frame memory and the second frame memory as shown in FIG. 4 is read from addresses as shown in FIG. 5A. As a result, the video data written into the first frame memory or the second frame memory is read and output as the third video data to be output in each bit to the display panel. In other words, in a time gray scale method, data corresponding to the video data for the sub-frame in the first bit can be output as shown in FIG. 5B. In a time gray scale method, the video data for the sub-frame in the second bit can be output as shown in FIG. 5C. That is, the video data can be output as shown in FIGS. 5B and 5C, in which the data is format-converted in a predetermined manner into the third video data and vertical-horizontal conversion thereof is conducted.

Note that, in this embodiment mode, as an example of vertical-horizontal conversion of the inputted video data, an example where video data is input to a panel having pixels in 5 rows and 6 columns, which is a display panel having pixels in 6 rows and 5 columns rotated to the left by 90°, is shown; however, the present invention is not limited thereto. The present invention can be applied to a video data control circuit and a display device including the video data control circuit which displays video data input to a display panel with predetermined digital gray scale and which needs rearrangement of the video data for displaying the data on the display panel.

Subsequently, timing of writing of video data to the first line memory and the second line memory and the first frame memory and the second frame memory in the structure of the present invention is described as well as an advantage of the present invention is described.

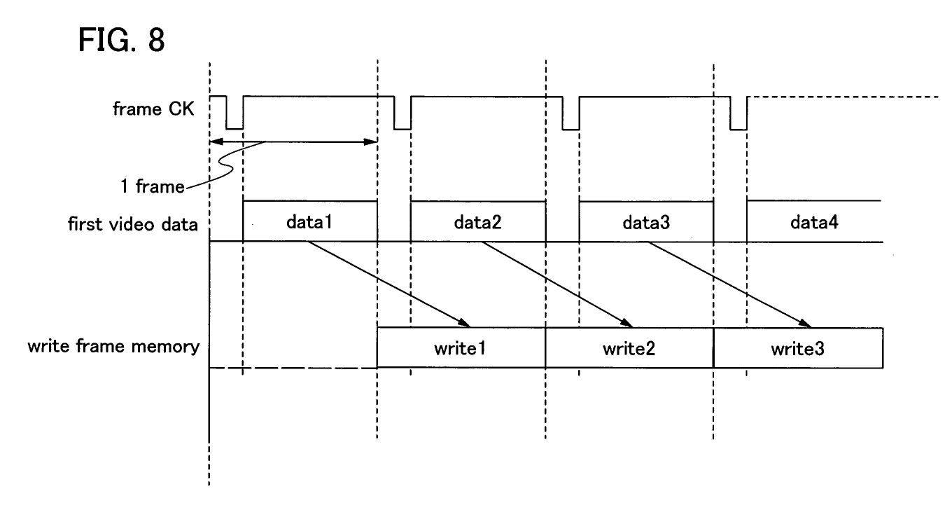

A timing chart shown in FIG. 8 shows a frame clock (a frame CK), the first video data, and a timing of writing to the first frame memory or the second frame memory. As shown in FIG. 8, in the present invention, the first video data is temporally stored in the video data storage portion and then is written to the frame memory, so that a margin of one frame period or more can be ensured. Therefore, a time margin can be provided even when the amount of information of video data is increased and a video data control circuit capable of higher speed operation of reading and writing is needed as a screen of the display panel becomes larger.

In addition, a time margin can be provided because a structure in which a video data storage portion and a video data format conversion portion of the present invention is provided is employed. Accordingly, a processing can be carried out without decrease in processing speed by sequential processing of writing and reading of video data in the memories. That is, improvement in processing speed by a so-called pipeline processing such as prevention of pipeline hazard, which is an interruption of the process accompanied by dependency of a plurality of instructions, can be achieved.

In addition, with the present invention, video data for either one of a horizontal display and a vertical display on the display panel is arranged using the line memory and the frame memory; therefore, when the video data is divided into sub-frames in the frame memory, the video data stored in the frame memory can be read sufficiently; accordingly, increase in power consumption and delay in access time in reading of the video data stored in the frame memory can be prevented. That is, lower power consumption and higher access speed can be realized in the video data control circuit.

Note that this embodiment mode can be implemented by being freely combined with any description of the other embodiment modes and embodiments in this specification.

### Embodiment Mode 2

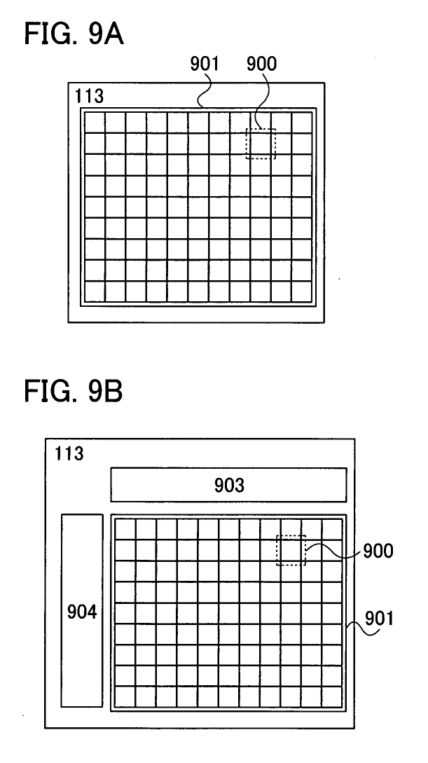

In Embodiment Mode 2, an example of the display panel 113 in FIGS. 1 and 2 is described with reference to FIGS. 9A and 9B. In FIG. 9A, the display panel 113 has a pixel portion 901 including a plurality of pixels 900 arranged in matrix. The pixel portion 901 can have an active matrix structure in which each pixel 900 is provided with a switching element such as a thin film transistor. As a display element in the pixel 900, a light emitting element such as an electroluminescence element or the like, or a liquid crystal element may be provided. In a case where a light emitting element is provided as a display element in the pixel 900, a light emission state (bright) or a non light emission state (dark) of the pixel 900 is selected by an image signal VD.

Note that, as shown in FIG. 9B, a drive circuit which drives the pixel portion 901 may be provided over the same substrate as the pixel portion 901. In FIG. 9B, portions that are the same as those in FIG. 9A are denoted by like reference numerals, and description thereof is omitted. In FIG. 9B, a first drive circuit 903 and a second drive circuit 904 are shown as drive circuits. Note that the present invention is not limited thereto and other drive circuits may be provided in addition to the first drive circuit 903 and the second drive circuit 904. The drive circuit may be formed over another substrate and may be mounted over the substrate provided with the pixel portion 901. In addition, the drive circuit may include a thin film transistor which is formed in the same process as the thin film transistor included in the pixel 900 and which is formed over the same substrate as the pixel portion 901. A channel formation region in the thin film transistor may be formed of a polycrystalline semiconductor or may be formed of an amorphous semiconductor.

This embodiment mode can be carried out by being freely combined with the other embodiment modes and embodiments. In other words, in a display device including the display panel described in this embodiment mode, increase in power consumption and delay in access time in reading of the video data stored in the frame memory can be prevented. That is, lower power consumption and higher access speed can be realized in the video data control circuit.

### Embodiment Mode 3

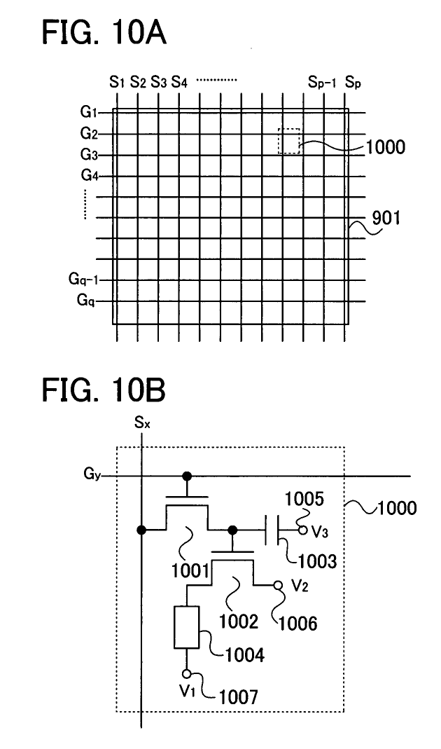

FIG. 10A shows an example of a structure (hereinafter, referred to as a first structure) of the pixel portion 901 shown in FIGS. 9A and 9B. The pixel portion 901 includes a plurality of first signal lines S₁ to Sₚ (p is a natural number), a plurality of second signal lines G₁ to G_{q} (q is a natural number) which are provided so as to intersect with the plurality of first signal lines S₁ to Sₚ, and a pixel 1000 is provided at each intersection of the first signal lines S₁ to Sₚ and the second signal lines G₁ to G_{q}.

A structure of the pixel 1000 in FIG. 10A is shown in FIG. 10B. FIG. 10B shows the pixel 1000 formed at an intersection of Sₓ (x is a natural number that is p or less) in the plurality of first signal lines S₁ to Sₚ, and G_{y} (y is a natural number that is q or less) in the plurality of second signal lines G₁ to G_{q}. The pixel 1000 includes a first transistor 1001, a second transistor 1002, a capacitor 1003, and a light emitting element 1004. Note that, in this embodiment mode, an example where an element which has a pair of electrodes and which emits light when current flows between the pair of electrodes is used as the light emitting element 1004 is shown. In addition, as the capacitor 1003, parasitic capacitance of the second transistor 1002 or the like may be actively used. The first transistor 1001 and the second transistor 1002 may be n-channel transistors or p-channel transistors. As the transistor included in the pixel 1000, a thin film transistor can be used.

The first transistor 1001 has a gate connected to the second signal line G_{y}, and a source and a drain, one of which is connected to the first signal line Sₓ and the other of which is connected to a gate of the second transistor 1002 and an electrode of the capacitor 1003. The other electrode of the capacitor 1003 is connected to a terminal 1005 to which potential V₃ is applied. The second transistor 1002 has a source and a drain, one of which is connected to an electrode of the light emitting element 1004 and the other of which is connected to a terminal 1006 to which potential V₂ is applied. The other electrode of the light emitting element 1004 is connected to a terminal 1007 to which potential V₁ is applied.

A display method of the pixel portion 901 shown in FIGS. 10A and 10B is described.

In each of a plurality of sub-frame periods in one frame period, image signals are input to all the pixels 1000 in the pixel portion 901. The inputted image signal is a digital signal. A method for inputting image signals to all the pixels 1000 is described as follows. While one of the plurality of second signal lines G₁ to G_{q} is selected, image signals are input to all of the plurality of first signal lines S₁ to Sₚ. Thus, image signals are input to pixels in one row in the pixel portion 901. The plurality of second signal lines G₁ to G_{q} are sequentially selected and a similar operation is performed. In this manner, image signals are input to all the pixels 1000 in the pixel portion 901.

An operation of the pixel 1000 is described in which an image signal is input through Sₓ, one of the plurality of first signal lines S₁ to Sₚ, while G_{y}, one of the plurality of second signal lines G₁ to G_{q}, is selected. When the second signal line G_{y} is selected, the first transistor 1001 is turned on. An on state of a TFT refers to a state in which a source and a drain thereof are electrically connected, and an off state of a TFT refers to a state in which the source and the drain thereof are electrically disconnected. When the first transistor 1001 is turned on, an image signal inputted to the first signal line Sₓ is input to the gate of the second transistor 1002 through the first transistor 1001. Whether the second transistor 1002 is turned on or off is selected depending on the inputted image signal. When the second transistor 1002 is turned on, drain current of the second transistor 1002 is fed to the light emitting element 1004 and the light emitting element 1004 emits light.

The potential V₂ and the potential V₃ are kept so that potential difference therebetween is always constant while the second transistor 1002 is turned on. The potential V₂ and the potential V₃ may be the same potential. In the case where the potential V₂ and the potential V₃ are the same potential, the terminal 1005 and the terminal 1006 may be connected to the same wiring. The potential V₁ and the potential V₂ are set so that predetermined potential difference therebetween is obtained when light emission of the light emitting element 1004 is selected. In this manner, current is fed to the light emitting element 1004 so that the light emitting element 1004 emits light.

Note that, in this embodiment mode, “a transistor is turned on” means that voltage between a gate and a source of the transistor exceeds a threshold voltage and current flows between the source and the drain, and “a transistor is turned off” means that the voltage between the gate and the source of the transistor does not exceed the threshold voltage and current does not flow between the source and the drain.

Note that, in this embodiment mode, one pixel corresponds to one element which can control brightness. Therefore, for example, one pixel expresses one color element by which brightness is expressed. Accordingly, in a case of a color display device including color elements of R (red), G (green), and B (blue), the smallest unit of an image includes three pixels: an R pixel, a G pixel, and a B pixel. Note that color elements are not limited to three colors and may be more colors, for example, RGBW (W is white) may be employed.

Note that, in this embodiment mode, connection refers to electrical connection. Therefore, in a structure disclosed by the present invention, an element capable of an electric connection (such as a switch, a transistor, a capacitor, an inductor, a resistor, or a diode) may be interposed in the predetermined connection.

Although a light emitting element is described as an example of a display element in this embodiment mode, any display element which conducts display in an active matrix display device operated with a gate line and a source line can be used. For example, a display medium whose contrast is varied by an electromagnetic action can be used as a display element, such as an EL element (an organic EL element, an inorganic EL element, or an EL element containing an organic substance and an inorganic substance), an electron emitting element, a liquid crystal element, electronic ink, a grating light valve (GLV), a plasma display panel (PDP), a digital micromirror device (DMD), a piezoceramic display device, or a carbon nanotube. An example of a display device using an EL element is an EL display. Examples of a display device using an electron emitting element are a field emission display (FED), an SED flat-panel display (SED: Surface-conduction Electron-emitter Display), and the like. An example of a display device using a liquid crystal element is a liquid crystal display. An example of a display device using electronic ink is electronic paper.

This embodiment mode can be freely combined and carried out in combination with the other embodiment modes and embodiments. In other words, in a display device including the pixel portion described in this embodiment mode, increase in power consumption and delay in access time in reading of the video data stored in the frame memory can be prevented. That is, lower power consumption and higher access speed can be realized in the video data control circuit.

### Embodiment Mode 4

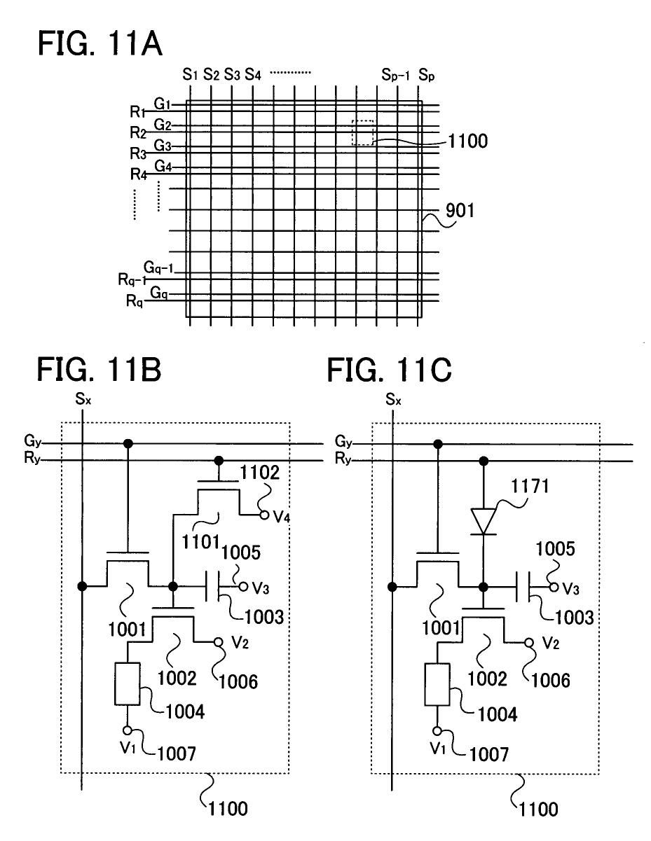

An example of a structure of the pixel portion 901 shown in FIGS. 9A and 9B is shown in FIG. 11A. In FIG. 11A, a structural example (hereinafter, referred to as a second structure) which is different from the first structure described in Embodiment Mode 3 is shown. The pixel portion 901 includes the plurality of first signal lines S₁ to Sₚ (p is a natural number), the plurality of second signal lines G₁ to G_{q} (q is a natural number) which is provided so as to intersect with the plurality of first signal lines Sᵢ to Sₚ, a plurality of third signal lines R₁ to R_{q}, and a pixel 1100 is provided at each intersection of the first signal lines S₁ to Sₚ, the second signal lines G₁ to G_{q}, and the third signal lines R₁ to R_{q}.

A structure of the pixel 1100 in FIG. 11A is shown in FIG. 11B. FIG. 11B shows the pixel 1100 formed at an intersection of Sₓ (x is a natural number as p or less) of the plurality of first signal lines S₁ to Sₚ, G_{y} (y is a natural number as q or less) of the plurality of second signal lines G₁ to G_{q}, and R_{y} of the plurality of third signal lines R₁ to R_{q}. Note that, in the pixel structure shown in FIG. 11B, portions that are the same as those in FIG. 10B are denoted by like reference numerals, and description thereof is omitted. The pixel in FIG. 11B differs from the pixel 1000 shown in FIG. 10B in that a third transistor 1101 is provided. The third transistor 1101 may be an n-channel transistor or a p-channel transistor. As a transistor included in the pixel 1100, a thin film transistor can be used.

The third transistor 1101 has a gate connected to the third signal line R_{y}, and a source and a drain, one of which is connected to the gate of the second transistor 1002 and an electrode of the capacitor 1003, and the other of which is connected to a terminal 1102 to which potential V₄ is applied.

A display method of the pixel portion 901 shown in FIGS. 11A and 11B is described.

The light emitting element 1004 emits light in the same manner as that described in Embodiment Mode 3. In the pixel with the structure shown in FIGS. 11A and 11B, the light emitting element 1004 in the pixel 1100 can be in a non light emission state without depending on an image signal input thereto from the first signal line Sₓ because the third signal line R_{y} and the third transistor 1101 are provided. The light emission period of the light emitting element 1004 in the pixel 1100 can be set with the signal input to the third signal line R_{y}. Thus, a light emission period shorter than the period of time it takes for sequentially selecting all the second signal lines G₁ to G_{q} can be set.

The potential V₄ may be set so that the second transistor 1002 is turned off when the third transistor 1101 is turned on. For example, the potential V₄ can be set so as to be the same as the potential V₃ when the third transistor 1101 is turned on. By setting the potential V₃ and the potential V₄ to be the same potential, charge stored in the capacitor 1003 can be discharged and voltage between the source and the gate of the second transistor 1002 is made zero, whereby the second transistor 1002 can be made to be in an off state. Note that, in the case where the potential V₃ and the potential V₄ are the same potential, the terminal 1005 and the terminal 1102 may be connected to the same wiring.

Note that the position of the third transistor 1101 is not limited to the one shown in FIG. 11B. For example, the third transistor 1101 may be disposed in series with the second transistor 1002. In this structure, the light emitting element 1004 can be made to be in the non light emission state by turning off the third transistor 1101 with the signal input to the third signal line R_{y} and stopping current flowing to the light emitting element 1004.

A diode can be used instead of the third transistor 1101 shown in FIG. 11B. A pixel structure in which a diode is used instead of the third transistor 1101 is shown in FIG. 11C. Note that, in FIG. 11C, portions the same as those in FIG. 11B are denoted by like reference numerals, and description thereof is omitted. A diode 1171 has an electrode which is connected to the third signal line R_{y}, and the other electrode which is connected to the gate of the second transistor 1002 and to an electrode of the capacitor 1003.

In the diode 1171, current flows from one electrode to the other electrode. A p-channel transistor is used as the second transistor 1002. The transistor 1002 can be turned off by increasing potential of one electrode of the diode 1171 and thereby increasing potential of the gate of the second transistor 1002.

FIG. 11C shows a structure of the diode 1171 in which current flows from the electrode connected to the third signal line R_{y} to the other electrode connected to the gate of the second transistor 1002, and in which a p-channel transistor is used as the second transistor 1002. However, the structure is not limited thereto. A structure of the diode 1171 in which current flows from the electrode connected to the gate of the second transistor 1002 to the other electrode connected to the third signal line R_{y}, and in which an n-channel transistor is used as the second transistor 1002 may be alternatively employed. When an n-channel transistor is used as the second transistor 1002, the second transistor 1002 can be turned off by decreasing potential of one electrode of the diode 1171, thereby decreasing potential of the gate of the second transistor 1002.

As the diode 1171, a diode-connected transistor may be used. A diode-connected transistor is a transistor in which a drain and a gate are connected to each other. As a diode-connected transistor, either a p-channel transistor or an n-channel transistor may be used.

This embodiment mode can be freely combined and carried out in combination with the other embodiment modes and embodiments. In other words, in a display device including the pixel portion described in this embodiment mode, increase in power consumption and delay in access time in reading of the video data stored in the frame memory can be prevented. That is, lower power consumption and higher access speed can be realized in the video data control circuit.

### Embodiment 1

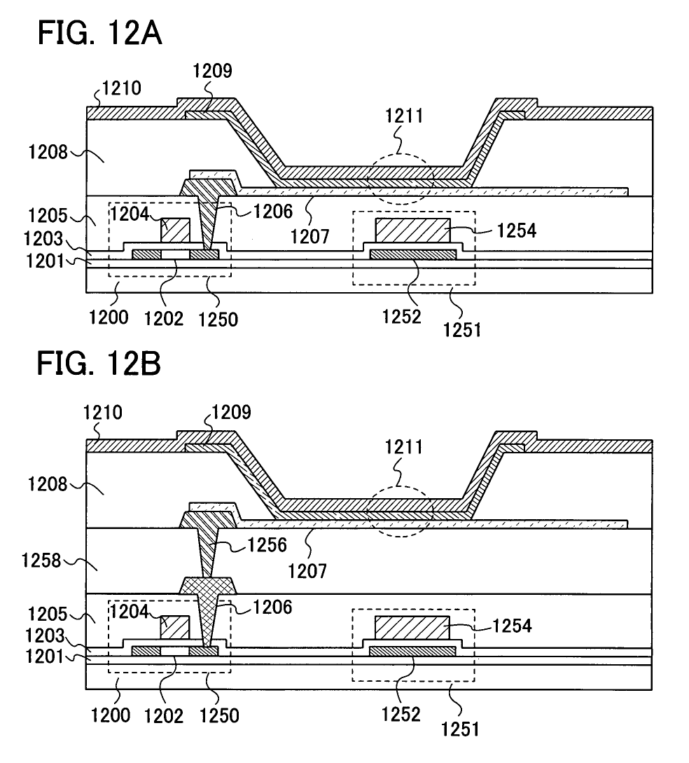

In this embodiment, an example where a pixel is actually manufactured is described. FIGS. 12A and 12B are cross-sectional views of a pixel in the panel described in Embodiment Modes 3 to 5. The example shown here includes a TFT as a switching element in a pixel and a light emitting element as a display element in the pixel.

In FIGS. 12A and 12B, there is a substrate 1200; a base film 1201; a semiconductor layer 1202; a semiconductor layer 1252; a first insulating film 1203; a gate electrode 1204; an electrode 1254; a second insulating film 1205; an electrode 1206; a first electrode 1207; a third insulating film 1208; a light emitting layer 1209; a second electrode 1210; a TFT 1250; a light emitting element 1211; and a capacitor 1251. In FIGS. 12A and 12B, the TFT 1250 and the capacitor 1251 are shown as typical examples of elements included in the pixel. A structure in FIG. 12A will be described.

As the substrate 1200, a substrate formed of a glass such as barium borosilicate glass or an alumino borosilicate glass, a quartz substrate, a ceramic substrate, or the like can be used, for example. Alternatively, a metal substrate containing stainless steel or a semiconductor substrate, having an insulating film formed on a surface may be used. As a further alternative, a substrate formed of a flexible synthetic resin such as plastic may be used. A surface of the substrate 1200 may be planarized by polishing using a CMP (Chemical Mechanical Polishing) method or the like.

As the base film 1201, an insulating film containing silicon oxide, silicon nitride, silicon nitride oxide (SiOₓN_{y} or SiNₓO_{y}, where x>y), or the like may be used. The base film 1201 can prevent an alkali metal such as Na or alkaline earth metal contained in the substrate 1200 from diffusing into the semiconductor layer 1202 and adversely affecting the characteristics of the TFT 1250. Although the base film 1201 has a single layer structure in FIGS. 12A and 12B, it may include two or more layers. Note that the base film 1201 is not necessarily provided in a case where a quartz substrate or the like in which diffusion of impurities is not a serious problem is used.

As the semiconductor layer 1202 and the semiconductor layer 1252, a crystalline semiconductor film or an amorphous semiconductor film processed into a desired shape can be used. The crystalline semiconductor film can be obtained by crystallizing an amorphous semiconductor film. As a crystallization method, a laser crystallization method, a thermal crystallization method using RTA (Rapid Thermal Annealing) or an annealing furnace, a thermal crystallization method using a metal element for accelerating crystallization, and the like can be employed. The semiconductor layer 1202 includes a channel formation region and a pair of impurity regions to which an impurity element for imparting a conductivity type is added. Note that impurity regions which include the impurity element for imparting a conductivity type at a lower concentration than the foregoing pair of impurity regions may be provided between the channel formation region and each of the pair of impurity regions. The semiconductor layer 1252 can have a structure in which an impurity element imparting a conductivity type is added to the whole layer.

The first insulating film 1203 can be formed of silicon oxide, silicon nitride, silicon nitride oxide, or the like, as a single layer or a stacked layer including a plurality of films.

As the gate electrode 1204 and the electrode 1254, a single layer or a stacked layer structure including an element selected from Ta, W, Ti, Mo, Al, Cu, Cr, or Nd, or an alloy or a compound containing a plurality of those elements can be used.

The TFT 1250 includes the semiconductor layer 1202, the gate electrode 1204, and the first insulating film 1203 which is between the gate electrode 1204 and the semiconductor layer 1202. Although only the TFT 1250, which is connected to the first electrode 1207 of the light emitting element 1211 is shown as a TFT included in the pixel is shown in FIGS. 12A and 12B, a plurality of TFTs may be provided. In addition, although the TFT 1250 is a top gate transistor in this embodiment, the TFT may be a bottom gate transistor in which a gate electrode is provided below a semiconductor layer, or the TFT may be a dual gate transistor where gate electrodes are provided both above and below a semiconductor layer.

The capacitor 1251 includes the first insulating film 1203 as a dielectric, and as a pair of electrodes, the semiconductor layer 1252 and the electrode 1254 facing each other with the first insulating film 1203 therebetween. In FIGS. 12A and 12B, an example is shown where the capacitor in the pixel includes the semiconductor layer 1252 which is formed at the same time as the semiconductor layer 1202 in the TFT 1250 as one of the pair of electrodes, and the electrode 1254 which is formed at the same time as the gate electrode 1204 in the TFT 1250 as the other electrode. However, note that the structure is not limited thereto.

As the second insulating film 1205, a single layer or a stacked layer of an inorganic insulating film or an organic insulating film can be used. As an inorganic insulating film, a silicon oxide film formed by a CVD method, a silicon oxide film applied by a SOG (Spin On Glass) method, or the like can be used. As an organic insulating film, a film formed of polyimide, polyamide, BCB (benzocyclobutene), acrylic, a positive photosensitive organic resin, a negative photosensitive organic resin, or the like can be used.

Alternatively, as the second insulating film 1205, a material having a skeleton including a bond between silicon (Si) and oxygen (O) can be used. As a substituent, an organic group including at least hydrogen (such as an alkyl group or an aromatic hydrocarbon) can be used. A fluoro group may be used as a substituent. Alternatively, an organic group including at least hydrogen and a fluoro group may be used as the substituent.

As the electrode 1206, a single layer or a stacked layer structure including an elements selected from Al, W, Mo, Ti, Pt, Cu, Ta, or Au, or an alloy containing a plurality of these elements can be used. Alternatively, as the electrode 1206, a single layer or a stacked layer structure including an alloy film containing one or plurality of elements selected from the foregoing elements and one or plurality of elements selected from Ni, C, or Mn can be used.

One or both of the first electrode 1207 and the second electrode 1210 can be transparent electrodes. A transparent electrode can be formed of indium tin oxide (ITO), zinc oxide (ZnO), indium zinc oxide (IZO), gallium-doped zinc oxide (GZO), or another light transmitting conductive oxide material. As a light transmitting conductive oxide material, indium tin oxide containing ITO and silicon oxide (hereinafter, abbreviated as ITSO), indium tin oxide containing ITO and titanium oxide (hereinafter, abbreviated as ITTO), or indium tin oxide containing ITO and molybdenum oxide (hereinafter, abbreviated as ITMO) can be used. Alternatively, ITO doped with titanium, molybdenum, or gallium; or a material which is formed using a target in which indium oxide containing silicon oxide includes zinc oxide (ZnO) at 2 to 20 wt %, or the like may be used as the light transmitting conductive oxide material.

The other one of the first electrode 1207 and the second electrode 1210 may be formed of a material which does not transmit light. For example, an alkali metal such as Li or Cs; alkaline earth metal such as Mg, Ca, or Sr; an alloy containing an element selected from those elements (such as Mg:Ag, Al:Li, or Mg:In); a compound containing such metals (such as CaF₂ or calcium nitride); or rare earth metals such as Yb or Er can be used.

The same materials can be used to form the third insulating film 1208 as those that can be used to form the second insulating film 1205. The third insulating film 1208 is formed over the first electrode 1207 so as to cover the edge thereof and separate the light emitting layers 1209 in adjacent pixels.

The light emitting layer 1209 may be formed as a single layer or a plurality of layers. In a case where the light emitting layer 1209 includes a plurality of layers, the layers can be classified as a hole injecting layer, a hole transporting layer, a light emitting layer, an electron transporting layer, an electron injecting layer, and the like, in terms of the carrier transporting properties. Note that a boundary between layers is not necessarily distinguishable and there may be a case where materials forming the layers are mixed partially and the boundary cannot be distinguished clearly. In each layer, an organic material or an inorganic material can be used. As an organic layer, any of a high molecular weight material, a medium molecular weight material, or a low molecular weight material can be used.

The light emitting element 1211 includes the light emitting layer 1209, and the first electrode 1207 and the second electrode 1210, which overlap each other with the light emitting layer 1209 therebetween. One of the first electrode 1207 and the second electrode 1210 serves as an anode and the other of which serves as a cathode. The light emitting element 1211 emits light when forward bias voltage higher than a threshold voltage is applied to the anode and the cathode and current flows from the anode to the cathode.

A structure in FIG. 12B is described. Note that portions the same as those in FIG. 12A are denoted by like reference numerals, and description thereof is omitted.

FIG. 12B shows a structure in which an insulating film 1258 is provided between the second insulating film 1205 and the third insulating film 1208 in the structure shown in FIG. 12A. The electrode 1206 and the first electrode 1207 are connected through the electrode 1256 in a contact hole provided in the insulating film 1258.

The insulating film 1258 can have a structure similar to that of the second insulating film 1205. The electrode 1256 can have a structure similar to that of the electrode 1206.

This embodiment can be freely combined and carried out in combination with the other embodiment modes and embodiments. In other words, in a display device including the panel described in this embodiment, increase in power consumption and delay in access time in reading of the video data stored in the frame memory can be prevented. That is, lower power consumption and higher access speed can be realized in the video data control circuit.

### Embodiment 2

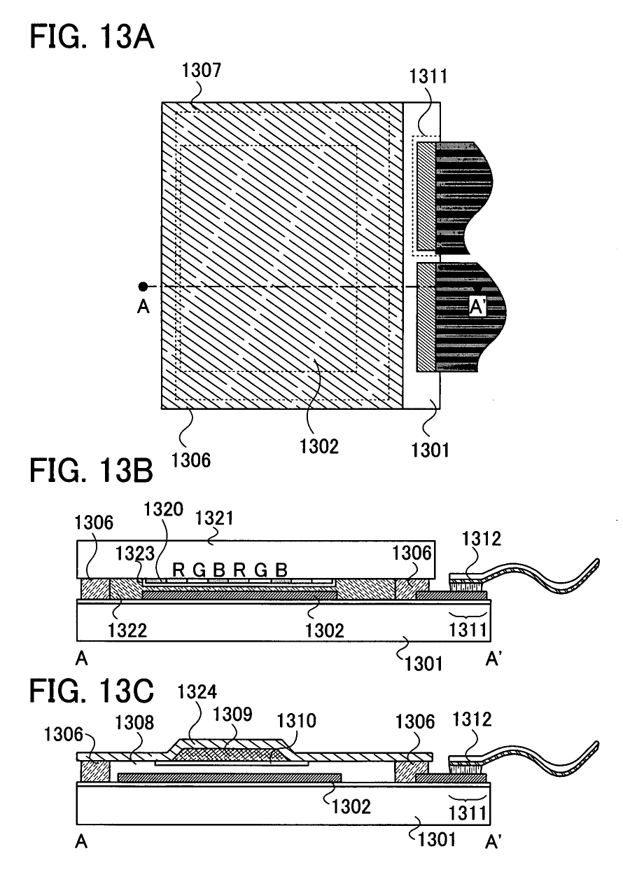

In this embodiment, a structure where a substrate provided with a pixel is sealed is described with reference to FIGS. 13A to 13C. FIG. 13A is a top view of a panel which is formed by sealing the substrate provided with the pixel. FIGS. 13B and 13C show cross sectional views taken along a line A-A′ in FIG. 13A. The example in FIG. 13B is sealed by a different method to the example in FIG. 13C.

In FIGS. 13A to 13C, a pixel portion 1302 including a plurality of pixels is located over the substrate 1301 and a sealant 1306 is provided so as to surround the pixel portion 1302, and a counter substrate 1307 is attached thereto. The pixels may have the structure shown in the foregoing embodiment modes or embodiment.

In the display panel shown in FIG. 13B, the transparent counter substrate 1321 is attached to the substrate 1301 using the sealant 1306 as an adhesive layer, so that an enclosed space 1322 is formed by the substrate 1301, the sealant 1306, and the counter substrate 1321. The counter substrate 1321 is provided with a color filter 1320 and a protective film 1323 for protecting the color filter. Light emitted from the light emitting element provided in the pixel portion 1302 is emitted to the outside through the color filter 1320. The enclosed space 1322 is filled with an inert resin, a liquid, or the like. As a resin for filling the enclosed space 1322, a light transmitting resin in which a desiccant is dispersed may be used. Note that the sealant 1306 and a material which fills the enclosed space 1322 may be the same material, and attachment of the counter substrate 1321 and sealing of the pixel portion 1302 may be conducted at the same time.

In the display panel show in FIG. 13C, the counter substrate 1324 is attached to the substrate 1301 using the sealant 1306 as an adhesive layer, so that an enclosed space 1308 is formed by the substrate 1301, the sealant 1306, and the counter substrate 1324. The counter substrate 1324 has a depression in which a desiccant 1309 is provided in advance, and maintains a clean atmosphere by adsorbing moisture, oxygen, and the like in the enclosed space 1308, thereby suppressing deterioration of the light emitting element. This depression is covered with a fine meshed cover material 1310. The cover material 1310 transmits air and moisture, but not the desiccant 1309. Note that the enclosed space 1308 may be filled with nitrogen or a rare gas such as argon. Alternatively, the enclosed space 1308 may be filled with a resin or a liquid, if it is inert.

An input terminal portion 1311 for transmitting a signal to the pixel portion 1302 and the like is provide over the substrate 1301. The input terminal portion 1311 receives a signal such as a video signal through an FPC (Flexible Printed Circuit) 1312. In the input terminal portion 1311, the wiring formed over the substrate 1301 and the wiring provided in the FPC 1312 are electrically connected to each other using a resin in which conductors are dispersed (anisotropic conductive resin: ACF).

A drive circuit for inputting a signal to the pixel portion 1302 may be formed over the substrate 1301 provided with the pixel portion 1302. Alternatively, the drive circuit for inputting a signal to the pixel portion 1302 may be formed with an IC chip, and be provided over the substrate 1301 and connected thereto with COG (Chip On Glass), or be provided over the substrate 1301 using TAB (Tape Automated Bonding) or a printed substrate.

This embodiment can be combined and carried out in combination with the other embodiment modes and embodiments. In other words, in a display device including the structure described in this embodiment, increase in power consumption and delay in access time in reading of the video data stored in the frame memory can be prevented. That is, lower power consumption and higher access speed can be realized in the video data control circuit.

### Embodiment 3

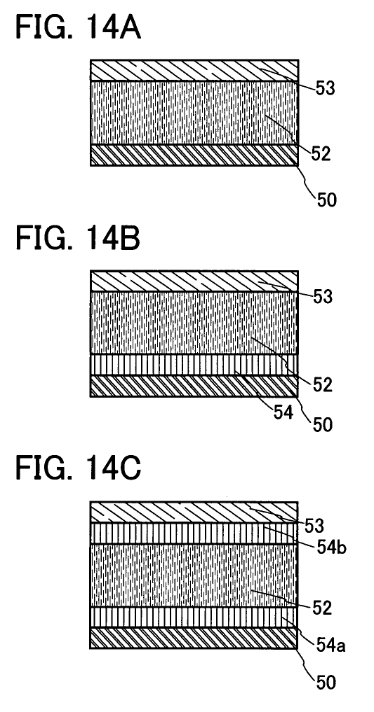

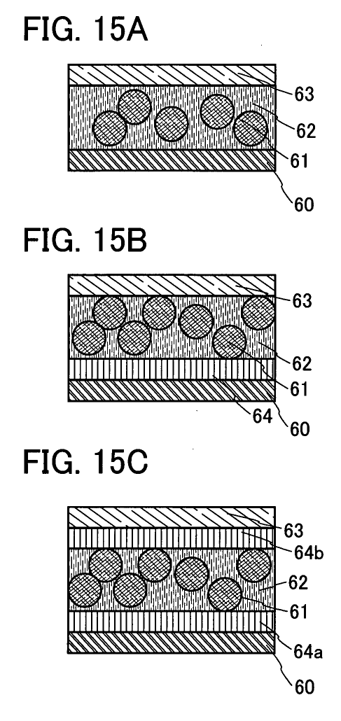

In this embodiment, another structure which can be applied to a light emitting element described in the foregoing embodiments is described with reference to FIGS. 14A to 15C.

Light emitting elements which utilize electroluminescence are classified according to whether their light emitting material is an organic compound or an inorganic compound. In general, light emitting elements having a light emitting material which is an organic compound are referred to as organic EL elements, while light emitting elements having a light emitting material which is an inorganic compound are referred to as inorganic EL elements.

An inorganic EL element is classified as either a dispersion type inorganic EL element or a thin-film type inorganic EL element, depending on its structure. Although these differ in that the former have an electroluminescent layer in which particles of a light emitting material are dispersed in a binder, whereas the latter have an electroluminescent layer formed of a thin film of a light emitting material, both need electrons accelerated by a high electric field. Mechanisms for obtaining light emission are donor-acceptor recombination light emission, which utilizes a donor level and an acceptor level, and localized light emission, which utilizes inner-shell electron transition of a metal ion. In general, in many cases, donor-acceptor recombination light emission is employed in dispersion type inorganic EL elements and localized light emission is employed in thin-film type inorganic EL elements.

A light emitting material that can be used in the present invention includes a base material and an impurity element that serves as a light emission center. Light emission of various colors can be obtained by changing the impurity element included. The light emitting material can be manufactured using various methods, such as a solid phase method or a liquid phase method (e.g., a coprecipitation method). Further, a liquid phase method, such as a spray pyrolysis method, a double decomposition method, a method which employs a pyrolytic reaction of a precursor, a reverse micelle method, a method in which one or more of the above methods are combined with high-temperature baking, a freeze-drying method, or the like can be used.

A solid phase method is a method in which a base material and an impurity element or a compound containing the impurity element are weighed, mixed in a mortar, and reacted by being heated and baked in an electric furnace, so that the impurity element is included in the base material. The baking temperature is preferably 700 to 1500° C. This is because a solid-phase reaction does not proceed when the temperature is too low, and the base material decomposes when the temperature is too high. The materials may be baked in powdered form; however, it is preferable to bake the materials in pellet form. A solid phase method needs a comparatively high temperature but is a simple method, and thus has high productivity and is suitable for mass production.

A liquid phase method (e.g., a coprecipitation method) is a method in which a base material or a compound containing the base material, and an impurity element or a compound containing the impurity element are reacted in a solution, dried, and then baked. The particles of the light emitting material are distributed uniformly, and the reaction can progress even if the particles are small and a baking temperature is low.

As the base material to be used for the light emitting material, a sulfide material, an oxide material, or a nitride material can be used. As a sulfide material, zinc sulfide (ZnS), cadmium sulfide (CdS), calcium sulfide (CaS), yttrium sulfide (Y₂S₃), gallium sulfide (Ga₂S₃), strontium sulfide (SrS), barium sulfide (BaS), or the like can be used, for example. As an oxide material, zinc oxide (ZnO), yttrium oxide (Y₂O₃), or the like can be used, for example. As a nitride material, aluminum nitride (AlN), gallium nitride (GaN), indium nitride (InN), or the like can be used, for example. Alternatively, zinc selenide (ZnSe), zinc telluride (ZnTe), or the like; or a ternary mixed crystal such as calcium gallium sulfide (CaGa₂S₄), strontium gallium sulfide (SrGa₂S₄), or barium gallium sulfide (BaGa₂S₄) may be used.

As a light emission center for localized light emission, manganese (Mn), copper (Cu), samarium (Sm), terbium (Th), erbium (Er), thulium (Tm), europium (Eu), cerium (Ce), praseodymium (Pr), or the like can be used. For charge compensation, a halogen element such as fluorine (F) or chlorine (Cl) may be added.

On the other hand, as a light emission center for donor-acceptor recombination light emission, a light emitting material containing a first impurity element for forming a donor level and a second impurity element forming an acceptor level can be used. As the first impurity element, fluorine (F), chlorine (Cl), aluminum (Al), or the like can be used, for example. As the second impurity element, copper (Cu), silver (Ag), or the like can be used, for example.

In a case where the light emitting material for donor-acceptor recombination light emission is synthesized using a solid phase method, a base material, the first impurity element or a compound containing the first impurity element, and the second impurity element or a compound containing the second impurity element are weighed, mixed in a mortar, heated and baked in an electric-furnace. As the base material, the foregoing base materials can be used. As the first impurity element and the compound containing the first impurity element, fluorine (F), chlorine (Cl), aluminum sulfide (Al₂S₃) or the like can be used, for example. As the second impurity element and the compound containing the second impurity element, copper (Cu), silver (Ag), copper sulfide (Cu₂S), silver sulfide (Ag₂S), or the like can be used, for example. The baking temperature is preferably 700 to 1500° C. This is because a solid-phase reaction does not proceed when the temperature is too low, and the base material decomposes when the temperature is too high. Baking may be conducted with the materials in powdered form; however, it is preferable to conduct baking with the materials in pellet form.

As the impurity element for a solid phase reaction, a compound containing the first impurity element and the second impurity element may also be used. In that case, the impurity elements are easily diffused and the solid phase reaction proceeds readily. Therefore, a uniform light emitting material can be obtained. In addition, a high purity light emitting material can be obtained, since an unnecessary impurity element is not included therein. As the compound containing the first impurity element and the second impurity element, for example, copper chloride (CuCl), silver chloride (AgCl), or the like can be used.

Note that the concentration of these impurity elements may be 0.01 to 10 atomic %, and is preferably 0.05 to 5 atomic %, with respect to the base material.

In a case of a thin-film type inorganic EL element, an electroluminescent layer is a layer containing the foregoing light emitting material, and can be formed using a vacuum evaporation method such as a resistive heating evaporation method or an electron beam evaporation (EB evaporation) method, a physical vapor deposition (PVD) method such as a sputtering method, a chemical vapor deposition (CVD) method such as a metal organic CVD method or a low-pressure hydride transport CVD method, an atomic layer epitaxy (ALE) method, or the like can be used.

Each of FIGS. 14A to 14C shows an example of a thin-film type inorganic EL element which can be used as the light emitting element. In FIGS. 14A to 14C, the light emitting element includes a first electrode layer 50, an electroluminescent layer 51, and a second electrode layer 53.

Each of FIGS. 14B and 14C shows a structure in which an insulating layer is provided between the electrode layer and the electroluminescent layer in the light emitting element shown in FIG. 14A. The light emitting element shown in FIG. 14B includes an insulating layer 54 between the first electrode layer 50 and the electroluminescent layer 52. The light emitting element shown in FIG. 14C includes an insulating layer 54a between the first electrode layer 50 and the electroluminescent layer 52, and an insulating layer 54b between the second electrode layer 53 and the electroluminescent layer 52. Thus, the insulating layer may be provided between the electroluminescent layer and one of the electrode layers sandwiching the electroluminescent layer, or may be provided between the electroluminescent layer and each of the electrode layers sandwiching the electroluminescent layer. In addition, the insulating layer may be a single layer or a stacked layer including a plurality of layers.

Note that although the insulating layer 54 is provided in contact with the first electrode layer 50 in FIG. 14B, the insulating layer 54 may be provided in contact with the second electrode layer 53 by reversing the positions of the insulating layer and the electroluminescent layer.

In a case of a dispersion type inorganic EL element, a film-shaped electroluminescent layer is formed by dispersing particles of light emitting material in a binder. In the case that a desired size of particle cannot be sufficiently obtained by a method of manufacturing the light emitting material, the light emitting materials may be processed into particles by being crushed in a mortar or the like. The binder is a substance for fixing dispersed particles of light emitting material in place and maintaining the shape of an electroluminescent layer. The light emitting material is dispersed evenly through the light emitting layer and fixed in place by the binder.

In a case of a dispersion type inorganic EL element, a method for forming the electroluminescent layer can be a droplet discharge method by which the electroluminescent layer can be selectively formed, a printing method (screen printing, offset printing, or the like), a coating method such as a spin coat method or the like, a dipping method, a dispenser method, or the like. There is no particular limitation on a thickness of a film, but preferably it is in a range of 10 to 1000 nm. In addition, in the electroluminescent layer containing the light emitting material and the binder, the weight percent of the light emitting material is preferably greater than or equal to 50 wt % and less than or equal to 80 wt %.

Each of FIGS. 15A to 15C shows an example of a dispersion type inorganic EL element which can be used as the light emitting element. A light emitting element shown in FIG. 15A has a stacked layer structure including a first electrode layer 60, an electroluminescent layer 62, and a second electrode layer 63. The electroluminescent layer 62 contains a light emitting material 61 fixed by a binder.

As a binder that can be used in this embodiment, an insulating material can be used. The binder may be an organic material or an inorganic material, or a mixed material containing an organic material and an inorganic material. As an organic insulating material, a polymer having comparatively high dielectric constant such as a cyanoethyl cellulose based resin or the like, or a resin such as polyethylene, polypropylene, a polystyrene based resin, a silicone resin, an epoxy resin, vinylidene fluoride, or the like can be used. Alternatively, a heat resistant high molecular weight material such as aromatic polyamide or polybenzimidazole, or a siloxane resin may be used. Note that a siloxane resin is a resin including a Si—O—Si bond. Siloxane has a skeleton structure having a bond between silicon (Si) and oxygen (O), and as a substituent, an organic group having at least hydrogen (such as an alkyl group or an aromatic hydrocarbon) is used. Alternatively, a fluoro group may be used as a substituent or both a fluoro group and an organic group containing at least hydrogen may be used. Further, a resin material such as a vinyl resin such as polyvinyl alcohol or polyvinylbutyral, a phenol resin, a novolac resin, an acrylic resin, a melamine resin, a urethane resin, an oxazole resin (e.g., polybenzoxazole), may be used. Fine particles having a high dielectric constant, such as particles of barium titanate (BaTiO₃) or strontium titanate (SrTiO₃) can also be mixed with these resins moderately to adjust the dielectric constant.

The inorganic insulating material contained in the binder can be formed using silicon oxide (SiOₓ), silicon nitride (SiNₓ), silicon containing oxygen and nitrogen, aluminum nitride (AlN), aluminum or aluminum oxide (Al₂O₃) containing oxygen and nitrogen, titanium oxide (TiO₂), BaTiO₃, SrTiO₃, lead titanate (PbTiO₃), potassium niobate (KNbO₃), lead niobate (PbNbO₃), tantalum oxide (Ta₂O₅), barium tantalate (BaTa₂O₆), lithium tantalate (LiTaO₃), yttrium oxide (Y₂O₃), zirconium oxide (ZrO₂), ZnS, or another material containing an inorganic material. When an inorganic material having a high dielectric constant is included in the organic material (by addition or the like), the dielectric constant of the electroluminescent layer containing the light emitting material and the binder can be more effectively controlled, and can be made even higher.

In a manufacturing process, the light emitting materials are dispersed in a solution containing the binder. As a solvent for a solution containing the binder which can be used in this embodiment, a solvent in which a binder material can be dissolved and which can form a solution having a viscosity suitable for a method for forming the electroluminescent layer (various wet processes) with a desired thickness may be appropriately selected. For example, an organic solvent or the like can be used. In a case of using a siloxane resin as a binder, for example, propylene glycol monomethyl ether, propylene glycol monomethyl ether acetate (also referred to as PGMEA), 3-methoxy-3-methyl-1-butanol (also referred to as MMB), or the like can be used.

Each of FIGS. 15B and 15C shows a structure in which an insulating layer is provided between the electrode layer and the electroluminescent layer in the light emitting element shown in FIG. 15A. The light emitting element shown in FIG. 15B includes an insulating layer 64 between the first electrode layer 60 and the electroluminescent layer 62. The light emitting element shown in FIG. 15C includes an insulating layer 64a between the first electrode layer 60 and the electroluminescent layer 62, and an insulating layer 64b between the second electrode layer 63 and the electroluminescent layer 62. Thus, the insulating layer may be provided between the electroluminescent layer and one of the electrode layers sandwiching the electroluminescent layer, or may be provided between the electroluminescent layer and each of the electrode layers sandwiching the electroluminescent layer. In addition, the insulating layer may be a single layer or a stacked layer including a plurality of layers.

Note that although the insulating layer 64 is provided in contact with the first electrode layer 60 in FIG. 15B, the insulating layer 64 may be provided in contact with the second electrode layer 63 by reversing the position of the insulating layer and the electroluminescent layer.

There is no particular limitation on the insulating layer 54 in FIGS. 14A to 14C and the insulating layer 64 in FIGS. 15A to 15C, but they preferably have high withstand voltage and are dense films. Further, the insulating layer preferably has high dielectric constant. For example, silicon oxide (SiO₂), yttrium oxide (Y₂O₃), titanium oxide (TiO₂), aluminum oxide (Al₂O₃), hafnium oxide (HfO₂), tantalum oxide (Ta₂O₅), barium titanate (BaTiO₃), strontium titanate (SrTiO₃), lead titanate (PbTiO₃), silicon nitride (Si₃N₄), zirconium oxide (ZrO₂), or the like can be used. Alternatively, a mixed film of those materials or a stacked layer film including two or more of those materials can be used. An insulating film of those materials can be formed by sputtering, vapor deposition, CVD, or the like. Alternatively, the insulating layer may be formed by dispersing particles of these insulating materials in a binder. A material for the binder may be the same as the binder contained in the electroluminescent layer and may be formed by the same method. There is no particular limitation on the film thickness, but preferably it is in a range of 10 to 1000 nm.

The light emitting element of this embodiment emits light when voltage is applied between the pair of electrode layers sandwiching the electroluminescent layer. The light emitting element of this embodiment can operate with either direct current driving or alternate current driving.

This embodiment can be combined and carried out in combination with the other embodiment modes or embodiments. In other words, in a display device including the light emitting element described in this embodiment, increase in power consumption and delay in access time in reading of the video data stored in the frame memory can be prevented. That is, lower power consumption and higher access speed can be realized in the video data control circuit.

### Embodiment 4

The present invention can be applied to a display module which has a circuit for inputting a signal to a panel mounted on the panel.

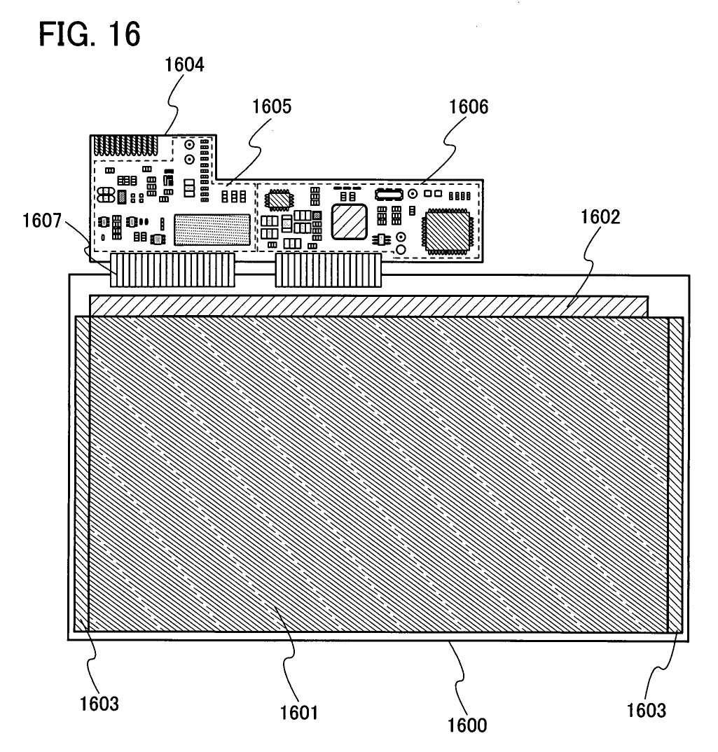

FIG. 16 shows a display module which has a panel 1600 combined with a circuit board 1604. In FIG. 16, an example where a controller 1605 and a signal division circuit 1606 and the like are formed over the circuit board 1604 is shown, but a circuit formed over the circuit board 1604 is not limited thereto. Any circuit which can generate a signal for controlling the panel may be used.

The signal output from these circuits formed over the circuit board 1604 is input to the panel 1600 through a connection wiring 1607.

The panel 1600 includes a pixel portion 1601 including a plurality of pixels, a first drive circuit 1602, and a second drive circuit 1603. A structure of the panel 1600 can be similar to the structure described in the foregoing embodiment modes, embodiments, and the like. In FIG. 16, an example where the first drive circuit 1602 and the second drive circuit 1603 are formed over the same substrate as the pixel portion 1601 is shown. However, a display module of the present invention is not limited thereto. Just the second drive circuit 1603 may be formed over the same substrate as the pixel portion 1601, and the first drive circuit 1602 may be formed over the circuit board. Alternatively, both the first drive circuit 1602 and the second drive circuit 1603 may be formed over the circuit board.

By including such a display module, display portions for various electronic devices can be formed.

This embodiment mode can be freely combined and carried out in combination with the other embodiment modes or embodiments. In other words, in a display device including the display module described in this embodiment mode, increase in power consumption and delay in access time in reading of the video data stored in the frame memory can be prevented. That is, lower power consumption and higher access speed can be realized in the video data control circuit.

### Embodiment 5

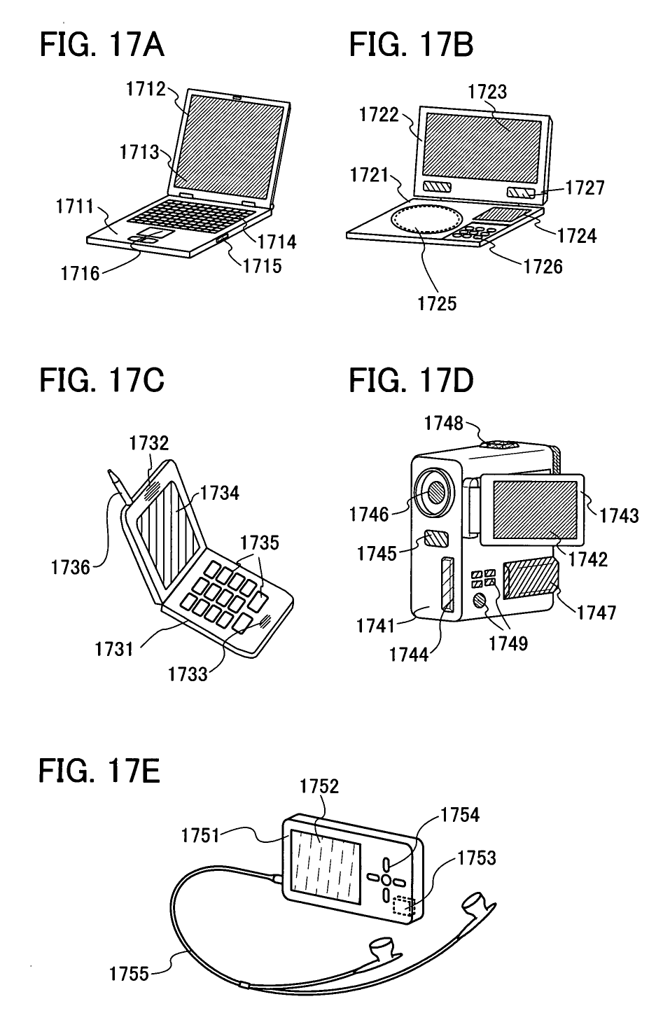

The present invention can be applied to a video data control circuit which inputs video data to a display portion in various electronic devices. Examples of such electronic devices are a camera (such as a video camera or a digital camera), a projector, a head-mounted display (a goggle display), a navigation system, a car stereo, a personal computer, a game machine, a portable information terminal (such as a mobile computer, a mobile phone, or an electronic book reader), an image reproducing device provided with a recording medium (specifically, a device for reproducing a recording medium such as a digital versatile disc (DVD), which has a display portion for displaying the reproduced image), and the like. FIGS. 17A to 17E show examples of electronic devices.

FIG. 17A shows a notebook personal computer, which includes a main body 1711, a housing 1712, a display portion 1713, a keyboard 1714, an external connection port 1715, a pointing device 1716, and the like. The present invention is applied to the display portion 1713. By employing the present invention, lower power consumption and higher access speed can be realized in the video data control circuit which inputs video data to a display panel.

FIG. 17B shows an image reproducing device provided with a recording medium (specifically, a DVD reproducing device), which includes a main body 1721, a housing 1722, a first display portion 1723, a second display portion 1724, a recording medium (e.g., a DVD) reading portion 1725, an operation key 1726, a speaker portion 1727, and the like. The first display portion 1723 mainly displays video data, while the second display portion 1724 mainly displays text data. The present invention is applied to the first display portion 1723 and the second display portion 1724. By employing the present invention, lower power consumption and higher access speed can be realized in the video data control circuit which inputs video data to a display panel.

FIG. 17C shows a mobile phone, which includes a main body 1731, an audio output portion 1732, an audio input portion 1733, a display portion 1734, operation switches 1735, an antenna 1736, and the like. The present invention is applied to the display portion 1734. By employing the present invention, lower power consumption and higher access speed can be realized in the video data control circuit which inputs video data to a display panel.

FIG. 17D shows a camera, which includes a main body 1741, a display portion 1742, a housing 1743, an external connection port 1744, a remote control receiving portion 1745, an image receiving portion 1746, a battery 1747, an audio input portion 1748, operation keys 1749, and the like. The present invention is applied to the display portion 1742. By employing the present invention, lower power consumption and higher access speed can be realized in the video data control circuit which inputs video data to a display panel.

FIG. 17E shows a digital player, which includes a main body 1751, a display portion 1752, a memory portion 1753, an operation portion 1754, an earphone 1755, and the like. The present invention is applied to the display portion 1752. Note that a headphone or a wireless earphone can be used instead of the earphone 1755. Note that power consumption can be suppressed by the display portion 1752 displaying white text on a black background. This is particularly effective in a portable audio device. Note also that the semiconductor memory device provided in the memory portion 1753 may be removable. By employing the present invention, lower power consumption and higher access speed can be realized in the video data control circuit which inputs video data to a display panel.

This embodiment mode can be freely combined and carried out in combination with the other embodiment modes or embodiments.

This application is based on Japanese Patent Application serial no. 2006-140851 filed in Japan Patent Office on May 19, in 2006, the entire contents of which are hereby incorporated by reference.

What is claimed is:

1. A video data control circuit comprising:
a video data storage portion which converts a first video data that is input thereto into a second video data which is output therefrom; and
a format conversion portion which converts a format of the second video data input thereto into video data for displaying in a predetermined digital gray scale,
wherein the video data storage portion includes a first line memory and a second line memory, and
wherein the first video data is written into the first line memory or the second line memory in a first order, and the written first video data is read out in a second order different from the first order and output to the format conversion portion as the second video data which is different from the first video data.

2. The video data control circuit according to claim 1, wherein the first video data and the second video data are multi-bit digital video data.

3. The video data control circuit according to claim 1, wherein the first line memory and the second line memory are volatile memories.

4. The video data control circuit according to claim 1, wherein the format conversion portion includes a first frame memory and a second frame memory, and bus widths of the first line memory and the second line memory are the same as bus widths of the first frame memory and the second frame memory.

5. A video data control circuit comprising:
a video data storage portion which converts a first video data input thereto into a second video data which is output therefrom; and
a format conversion portion which converts a format of the second video data input thereto into video data in which one frame period is divided into n sub-frame periods, wherein n is a natural number of 2 or more, and lighting or non-lighting is selected for each pixel in each of the n sub-frame periods so as to express a gray scale,
wherein the video data storage portion includes a first line memory and a second line memory, and
wherein the first video data is written into the first line memory or the second line memory in a first order, and the written first video data is read out in a second order different from the first order and output to the format conversion portion as the second video data which is different from the first video data.

6. The video data control circuit according to claim 5, wherein the first video data and the second video data are multi-bit digital video data.

7. The video data control circuit according to claim 5, wherein the first line memory and the second line memory are volatile memories.

8. The video data control circuit according to claim 5, wherein the format conversion portion includes a first frame memory and a second frame memory, and bus widths of the first line memory and the second line memory are the same as bus widths of the first frame memory and the second frame memory.

9. A display device comprising:
a display panel having a plurality of pixels; and
a video data control circuit which comprises a video data storage portion which converts a first video data input thereto into second video data which is output therefrom; and a format conversion portion which converts a format of the second video data input thereto into a third video data for displaying in a predetermined digital gray scale,
wherein the third video data is supplied to the display panel,
wherein the video data storage portion includes a first line memory and a second line memory, and
wherein the first video data is written into the first line memory or the second line memory in a first order, and the written first video data is read out in a second order different from the first order and output to the format conversion portion as the second video data which is different from the first video data.

10. The display device according to claim 9, wherein the first video data, the second video data, and the third video data are multi-bit digital video data.

11. The display device according to claim 9, wherein the first line memory and the second line memory are volatile memories.

12. The display device according to claim 9, wherein the format conversion portion includes a first frame memory and a second frame memory, and bus widths of the first line memory and the second line memory are the same as bus widths of the first frame memory and the second frame memory.

13. The display device according to claim 9, wherein the display device is provided in a display portion of an electronic device.

14. A display device comprising:
a display panel having a plurality of pixels; and
a video data control circuit which comprises a video data storage portion which converts a first video data input thereto into a second video data which is output therefrom, and a format conversion portion which converts a format of the second video data input thereto into a third video data in which one frame period is divided into n sub-frame periods, wherein n is a natural number of 2 or more, and lighting or non-lighting is selected for each pixel in each of the n sub-frame periods so as to express a gray scale,
wherein the third video data is supplied to the display panel,
wherein the video data storage portion includes a first line memory and a second line memory, and
wherein the first video data is written into the first line memory or the second line memory in a first order, and the written first video data is read out in a second order different from the first order and output to the format conversion portion as the second video data which is different from the first video data.

15. The display device according to claim 14, wherein the first video data, the second video data, and the third video data are multi-bit digital video data.

16. The display device according to claim 14, wherein the first line memory and the second line memory are volatile memories.

17. The display device according to claim 14, wherein the format conversion portion includes a first frame memory and a second frame memory, and bus widths of the first line memory and the second line memory are the same as bus widths of the first frame memory and the second frame memory.

18. The display device according to claim 14, wherein the display device is provided in a display portion of an electronic device.

19. A drive method of a video data control circuit comprising:
a video data storage portion which converts a first video data input thereto into a second video data which is output therefrom, and includes a first line memory and a second line memory; and
a format conversion portion which converts a format of the second video data input thereto into video data for displaying in a predetermined digital gray scale,
wherein the first video data is written into the first line memory or the second line memory in a first order, and the written first video data is read out in a second order different from the first order and output to the format conversion portion as the second video data which is different from the first video data.

20. The drive method of the video data control circuit according to claim 19, wherein the first video data and the second video data are multi-bit digital video data.

21. The drive method of the video data control circuit according to claim 19, wherein the first line memory and the second line memory are volatile memories.

22. The drive method of the video data control circuit according to claim 19, wherein the format conversion portion includes a first frame memory and a second frame memory, and bus widths of the first line memory and the second line memory are the same as bus widths of the first frame memory and the second frame memory.

23. A drive method of a video data control circuit having
a video data storage portion which converts a first video data input thereto into a second video data which is output therefrom, and includes a first line memory and a second line memory; and
a format conversion portion which converts a format of the second video data input thereto into video data in which one frame period is divided into n sub-frame periods, wherein n is a natural number of 2 or more, and lighting or non-lighting is selected for each pixel in each of the n sub-frame periods so as to express gray scale,
wherein the first video data is written into the first line memory or the second line memory in a first order, and the written first video data is read out in a second order different from the first order and output to the format conversion portion as the second video data which is different from the first video data.

24. The drive method of the video data control circuit according to claim 23, wherein the first video data and the second video data are multi-bit digital video data.

25. The drive method of the video data control circuit according to claim 23, wherein the first line memory and the second line memory are volatile memories.

26. The drive method of the video data control circuit according to claim 23, wherein the format conversion portion includes a first frame memory and a second frame memory, and bus widths of the first line memory and the second line memory are the same as bus widths of the first frame memory and the second frame memory.
